(19) United States
(12) Patent Application Publication
(10) Pub. No.: US 2017/0117979 A1
(43) Pub. Date: Apr. 27, 2017

(54) ALTERNATING PSEUDO-RANDOM BINARY SEQUENCE SEEDS FOR MIPI CSI-2 C-PHY

(71) Applicant: QUALCOMM Incorporated, San Diego, CA (US)

(72) Inventors: Shoichiro Sengoku, San Diego, CA (US); George Alan Wiley, San Diego, CA (US)

(21) Appl. No.: 15/253,020

(22) Filed: Aug. 31, 2016

Related U.S. Application Data
(60) Provisional application No. 62/245,148, filed on Oct. 22, 2015.
(60) Provisional application No. 62/377,876, filed on Aug. 22, 2016.
(60) Provisional application No. 62/380,841, filed on Aug. 29, 2016.

(51) Int. Cl. H04J 3/06; H04L 12/741; G06F 13/42; H04L 25/03; H04L 9/06; G06F 21/60

(52) U.S. Cl. CPC H04J 3/0605; H04L 9/0618; G06F 21/606; G06F 13/4282; H04L 25/03866; H04L 45/74; H04L 1/0061

(57) ABSTRACT

System, methods and apparatus are described that support multimode operation of a data communication interface. A method includes initializing a scrambler with a first pseudo-random binary sequence (PRBS) seed word after receiving a first sync word, the first sync word preceding a first packet, using the scrambler and the first PRBS seed word to scramble a first copy of a packet header that succeeds the first sync word in the first packet, initializing the scrambler with a second PRBS seed word after scrambling the first copy of the packet header, the second sync word succeeding the first copy of the packet header in the first packet, using the scrambler and the second PRBS seed word to scramble a second copy of the packet header that succeeds the second sync word in the first packet.

### CROSS-REFERENCE TO RELATED APPLICATIONS

This application claims the benefit of U.S. Provisional Application Ser. No. 62/245,148 filed in the U.S. Patent Office on Oct. 22, 2015, U.S. Provisional Application Ser. No. 62/377,876 filed in the U.S. Patent Office on Aug. 22, 2016, and U.S. Provisional Application Ser. No. 62/380,841 filed in the U.S. Patent Office on Aug. 29, 2016, the entire content of these applications being incorporated herein by reference and for all applicable purposes.

### TECHNICAL FIELD

At least one aspect generally relates to data communications interfaces, and more particularly, to data communications interfaces configurable for communicating between integrated circuit devices.

### BACKGROUND

Manufacturers of mobile devices, such as cellular phones, may obtain components of the mobile devices from various sources, including different manufacturers. For example, the application processor in a cellular phone may be obtained from a first manufacturer, while the display for the cellular phone may be obtained from a second manufacturer. Moreover, multiple standards are defined for interconnecting certain components of the mobile devices. For example, there are multiple types of interface defined for communications between an application processor and display and camera components of a mobile device. Some components employ an interface that conforms to one or more standards specified by the Mobile Industry Processor Interface (MIPI) Alliance. For example, the MIPI Alliance defines protocols for a camera serial interface (CSI) and a display serial interface (DSI).

MIPI CSI-2 and MIPI DSI or DSI-2 standards define a wired interface between a camera and application processor, or an application processor and display. The low-level physical-layer (PHY) interface in each of these applications can be MIPI C-PHY or MIPI D-PHY. High-speed modes and low-power modes of communication are defined for MIPI C-PHY or MIPI D-PHY. The MIPI C-PHY high-speed mode uses a low-voltage multiphase signal transmitted in different phases on a 3-wire link. The MIPI D-PHY high-speed mode uses a plurality of 2-wire to carry low-voltage differential signals. The low-power mode of MIPI C-PHY and MIPI D-PHY provides lower rates than the high-speed mode and transmits signals at higher voltages where the high-speed signals are undetectable by receivers configured for low-power operation.

As device technology improves, higher data rates and lower-power consumption may be obtained when devices are operated at lower voltage levels. Increased data rates and decreased voltages may result in increased susceptibility to electromagnetic interference and other sources of interference. There is an ongoing need to improve MIPI C-PHY and MIPI D-PHY interfaces to take advantage of technology improvements to maintain link reliability while increasing data rates.

### SUMMARY

Certain aspects of the disclosure relate to provide systems, methods and apparatus that enable packets to be scrambled using at least two seed codes, where a different seed code is used for a duplicate pair of packet headers of a single packet. According to certain aspects described herein, two or more Integrated Circuit (IC) devices may be collocated in an electronic apparatus and communicatively coupled through one or more data links that can be configured with one of a plurality of interface standards.

In an aspect of the disclosure, a method for scrambling packets to be transmitted on a multi-wire transition-encoded interface may be performed by one of the IC devices. The method may include initializing a scrambler with a first pseudo-random binary sequence (PRBS) seed word after receiving a first sync word, the first sync word preceding a first packet, using the scrambler and the first PRBS seed word to scramble a first copy of a packet header that succeeds the first sync word in the first packet, initializing the scrambler with a second PRBS seed word after scrambling the first copy of the packet header, the second sync word succeeding the first copy of the packet header in the first packet, using the scrambler and the second PRBS seed word to scramble a second copy of the packet header that succeeds the second sync word in the first packet.

In an aspect of the disclosure, an apparatus has a physical interface configured for communicating over a multi-wire transition-encoded interface, a scrambler, and a processor. The processor may be configured to initialize a scrambler with a first PRBS seed word after receiving a first sync word, the first sync word preceding a first packet, cause the scrambler to scramble a first copy of a packet header that succeeds the first sync word in the first packet using the first PRBS seed word, initialize the scrambler with a second PRBS seed word after scrambling the first copy of the packet header, the second sync word succeeding the first copy of the packet header in the first packet, cause the scrambler to scramble a second copy of the packet header that succeeds the second sync word in the first packet using the second PRBS seed word.

In an aspect of the disclosure, a processor readable storage medium includes code for initializing a scrambler with a first PRBS seed word after receiving a first sync word, the first sync word preceding a first packet, using the scrambler and the first PRBS seed word to scramble a first copy of a packet header that succeeds the first sync word in the first packet, initializing the scrambler with a second PRBS seed word after scrambling the first copy of the packet header, the second sync word succeeding the first copy of the packet header in the first packet, using the scrambler and the second PRBS seed word to scramble a second copy of the packet header that succeeds the second sync word in the first packet.

In an aspect of the disclosure, and apparatus includes means for initializing a scrambler with a first PRBS seed word after receiving a first sync word, the first sync word preceding a first packet, means for using the scrambler and the first PRBS seed word to scramble a first copy of a packet header that succeeds the first sync word in the first packet, means for initializing the scrambler with a second PRBS seed word after scrambling the first copy of the packet header, the second sync word succeeding the first copy of the packet header in the first packet, and means for using the scrambler and the second PRBS seed word to scramble a second copy of the packet header that succeeds the second sync word in the first packet.

In an aspect of the disclosure, a method for descrambling packets received a multi-wire transition-encoded interface includes initializing a first descrambler with a first PRBS seed word after receiving a first sync word, the first sync word preceding a first packet, using the first descrambler and the first PRBS seed word to descramble a first copy of a packet header that succeeds the first sync word in the first packet, initializing the first descrambler with a second PRBS seed word after receiving a second sync word, the second sync word succeeding the first copy of the packet header in the first packet, and using the first descrambler and the second PRBS seed word to descramble a second copy of the packet header that succeeds the second sync word in the first packet.

In an aspect of the disclosure, an apparatus includes means for configuring one or more descramblers, and configured to initialize a first descrambler with a first PRBS seed word after receiving a first sync word, the first sync word preceding a first packet, and initializing the first descrambler with a second PRBS seed word after receiving a second sync word. The apparatus may also include means for descrambling a first copy of a packet header that succeeds the first sync word in the first packet, using the first descrambler and the first PRBS seed word, and means for descrambling a second copy of the packet header that succeeds the second sync word in the first packet, using the first descrambler and the first PRBS seed word, where the second sync word follows the first copy of the packet header in the first packet.

In various aspects of the disclosure, a method for scrambling packets to be transmitted on a multi-wire transition-encoded interface may be performed by one of the IC devices. The method may include providing a first sync word, the first sync word being associated with a first packet, initializing a scrambler with a first PRBS seed word after providing the first sync word, using the scrambler and the first PRBS seed word to scramble a first copy of a packet header to obtain a first scrambled packet header, providing a second sync word, the second sync word being associated with the first packet, initializing the scrambler with a second PRBS seed word after providing the second sync word, and using the scrambler and the second PRBS seed word to scramble a second copy of the packet header to obtain a second scrambled packet header. In some instances, the method includes transmitting the first sync word followed by the first scrambled packet header on the multi-wire transition-encoded interface, after transmitting the first scrambled packet header, transmitting the second sync word followed by the second scrambled packet header on the multi-wire transition-encoded interface, and after transmitting the second scrambled packet header, transmitting the packet on the multi-wire transition-encoded interface.

In one aspect, the method includes providing a third sync word, and initializing the scrambler with a third PRBS seed word after providing the third sync word. The third sync word may be associated with a second packet. In one example, the first sync word and the third sync word have the same value. In another example, the first sync word, the second sync word, and the third sync word have different values. In some implementations, the first sync word is transmitted on the multi-wire transition-encoded interface only when the scrambler is initiated with the first PRBS seed word, the second sync word is transmitted on the multi-wire transition-encoded interface only when the scrambler is initiated with the second PRBS seed word, and the third sync word is transmitted on the multi-wire transition-encoded interface only when the scrambler is initiated with the third PRBS seed word.

In one example, the first sync word, the second sync word, and the third sync word may be selected according to a pseudorandom sequence. The type or value of the sync word to be transmitted may be used to determine which seed word is provided for initializing the scrambler. In one example, the first PRBS seed word is used for scrambling after the first sync word is transmitted, the first PRBS seed word is used for scrambling after the second sync word is transmitted, and the first PRBS seed word is used for scrambling after the third sync word is transmitted.

In one aspect, the method includes scrambling a payload of the first packet using the second PRBS seed word, and encoding the first packet in sequences of symbols after scrambling the first copy of the packet header, the second copy of the packet header and the payload of the first packet. The method may include transmitting the first packet over the multi-wire transition-encoded interface in sequences of symbols after scrambling the first copy of the packet header, the second copy of the packet header and the payload of the first packet.

In various aspects of the disclosure, an apparatus has a physical interface configured for communicating over a multi-wire transition-encoded interface, a scrambler, and a processor. The processor may be configured to provide a first sync word, the first sync word being associated with a first packet, initialize the scrambler with a first PRBS seed word after providing the first sync word, cause the scrambler to scramble a first copy of a packet header using the first PRBS seed word to obtain a first scrambled packet header, provide a second sync word, the second sync word being associated with the first packet, initialize the scrambler with a second PRBS seed word after providing the second sync word, and cause the scrambler to scramble a second copy of the packet header using the second PRBS seed word to obtain a second scrambled packet header.

In one aspect, the multi-wire transition-encoded interface is a C-PHY interface defined by MIPI Alliance specifications.

In one aspect, the processor is configured to transmit the first sync word followed by the first scrambled packet header on the multi-wire transition-encoded interface, transmit the second sync word followed by the second scrambled packet header on the multi-wire transition-encoded interface after transmitting the first scrambled packet header, and transmit the packet on the multi-wire transition-encoded interface after transmitting the second scrambled packet header.

In one aspect, the processor is configured to provide a third sync word, the third sync word being associated with a second packet, and initialize the scrambler with a third PRBS seed word after providing the third sync word. The first sync word and the third sync word may have a same value. The first sync word, the second sync word, and the third sync word may have different values. The first sync word may be transmitted on the multi-wire transition-encoded interface only when the scrambler is initiated with the first PRBS seed word. The second sync word may be transmitted on the multi-wire transition-encoded interface only when the scrambler is initiated with the second PRBS seed word. The third sync word may be transmitted on the multi-wire transition-encoded interface only when the scrambler is initiated with the third PRBS seed word. The first sync word, the second sync word, and the third sync word may be selected according to a pseudorandom sequence. The type or value of the sync word to be transmitted may be used to determine which seed word is provided for initializing the scrambler.

In one aspect, the processor may be configured to cause the scrambler to scramble a payload of the first packet using the second PRBS seed word, and encode the first packet in sequences of symbols after the first copy of the packet header, the second copy of the packet header and the payload of the first packet have been scrambled, wherein clock information is embedded in transitions between each pair of consecutive symbols in the sequences of symbols.

In an aspect of the disclosure, a processor readable storage medium is disclosed. The storage medium may be a non-transitory storage medium and may store code that, when executed by one or more processors, causes the one or more processors to provide a first sync word, the first sync word being associated with a first packet, initialize a scrambler with a first PRBS seed word after providing the first sync word, use the scrambler and the first PRBS seed word to scramble a first copy of a packet header to obtain a first scrambled packet header, provide a second sync word, the second sync word being associated with the first packet, initialize the scrambler with a second PRBS seed word after providing the second sync word, and use the scrambler and the second PRBS seed word to scramble a second copy of the packet header to obtain a second scrambled packet header. In some instances, the storage medium includes code that causes the one or more processors to transmit the first sync word followed by the first scrambled packet header on the multi-wire transition-encoded interface, after transmitting the first scrambled packet header, transmit the second sync word followed by the second scrambled packet header on the multi-wire transition-encoded interface, and after transmitting the second scrambled packet header, transmit the packet on the multi-wire transition-encoded interface.

In various aspects of the disclosure, an apparatus includes means for providing sync words, means for scrambling data for transmission based on the sync words. The means for providing sync words may be configured to provide a first sync word and a second sync word. The means for scrambling data may include a scrambler that is initialized by a first PRBS seed word, which is used to scramble a first copy of a packet header to obtain a first scrambled packet header that is transmitted after the first sync word. The scrambler may be initialized with a second PRBS seed word, which is used to scramble a second copy of the packet header to obtain a second scrambled packet header that is transmitted after the second sync word. In one example, the first sync word, the second sync word, and the third sync word may be different. The first sync word, the second sync word, and the third sync word may be selected according to a pseudorandom sequence. The type or value of the sync word to be transmitted may be used to determine which seed word is provided for initializing the scrambler. In one example, the first PRBS seed word is used for scrambling after the first sync word is transmitted, the first PRBS seed word is used for scrambling after the second sync word is transmitted, and the first PRBS seed word is used for scrambling after the third sync word is transmitted.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 depicts an apparatus employing a data link between integrated circuit (IC) devices that selectively operates according to one of plurality of available standards.

FIG. 2 illustrates a system architecture for an apparatus employing a data link between IC devices.

FIG. 3 illustrates an example of a 3-phase polarity data encoder of a C-PHY interface.

FIG. 4 illustrates signaling in an example in a C-PHY interface.

FIG. 5 illustrates certain aspects of a receiver in a C-PHY interface.

FIG. 6 illustrates an example of differential signaling lanes that may be employed in a D-PHY interface.

FIG. 7 illustrates certain aspects of a configuration of drivers and receivers in a D-PHY interface.

FIG. 8 illustrates examples of apparatus that may be adapted according to certain aspects disclosed herein.

FIG. 9 illustrates high-speed and low-power signaling in C-PHY and D-PHY interfaces.

FIG. 10 illustrates transitions between signaling modes in an example of a D-PHY interface.

FIG. 11 illustrates certain aspects of a data packet that may be transmitted on a D-PHY interface.

FIG. 12 illustrates certain aspects of a CSI-2 packet structure used for transmitting data packet through C-PHY interface.

FIG. 13 illustrates certain aspects of a DSI-2 packet structure used for transmitting data packet through a C-PHY interface.

FIG. 14 illustrates the use of different Sync Word values in a C-PHY interface according to certain aspects disclosed herein.

FIG. 15 illustrates an example of an apparatus adapted to support multiple Sync Word types in accordance with certain aspects disclosed herein.

FIG. 16 illustrates certain aspects related to the scrambling of a data packet that may be transmitted on a C-PHY interface.

FIG. 17 illustrates a first example in which C-PHY data packets are scrambled using multiple PRBS seed words in accordance with certain aspects disclosed herein.

FIG. 18 illustrates a second example in which C-PHY data packets are scrambled using multiple PRBS seed words in accordance with certain aspects disclosed herein.

FIG. 19 is a diagram illustrating an example of an apparatus employing a processing circuit that may be adapted according to certain aspects disclosed herein.

FIG. 20 is a flow chart illustrating a first example of a data transfer method operational on a transmitting one of two devices in an apparatus.

FIG. 21 is a flow chart illustrating a second example of a data transfer method operational on a transmitting one of two devices in an apparatus.

FIG. 22 is a diagram illustrating a first example of a hardware implementation for an apparatus employing a processing employing a processing circuit adapted according to certain aspects disclosed herein.

FIG. 23 is a flow chart of a data transfer method operational on a receiving one of two devices in an apparatus.

FIG. 24 is a diagram illustrating a second example of a hardware implementation for an apparatus employing a processing employing a processing circuit adapted according to certain aspects disclosed herein.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

Several aspects of data communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

Overview

According to certain aspects disclosed herein, the occurrence of identical scrambled symbol sequences can be avoided in C-PHY interfaces through the use of multiple PRBS seed values. For example, a scrambler that scrambles packet headers is initialized with a different seed value for each of two duplicate copes of packet headers transmitted consecutively over a C-PHY interface. The scramblers may be initialized after transmission of the sync symbol sequence transmitted before each copy of the packet header. According to certain aspects disclosed herein, different Sync Word values can be used in the sync symbol sequence. The Sync Word values can be used by a transmitter to signal information related to information transmitted after a sync symbol sequence. In one example, different Sync Word values can be used to identify different seed values to be used to initialize a scrambler. In other examples, the different Sync Word values can be used to identify types or portions of data transmitted as payloads.

Example of a Device Employing Transition Encoding

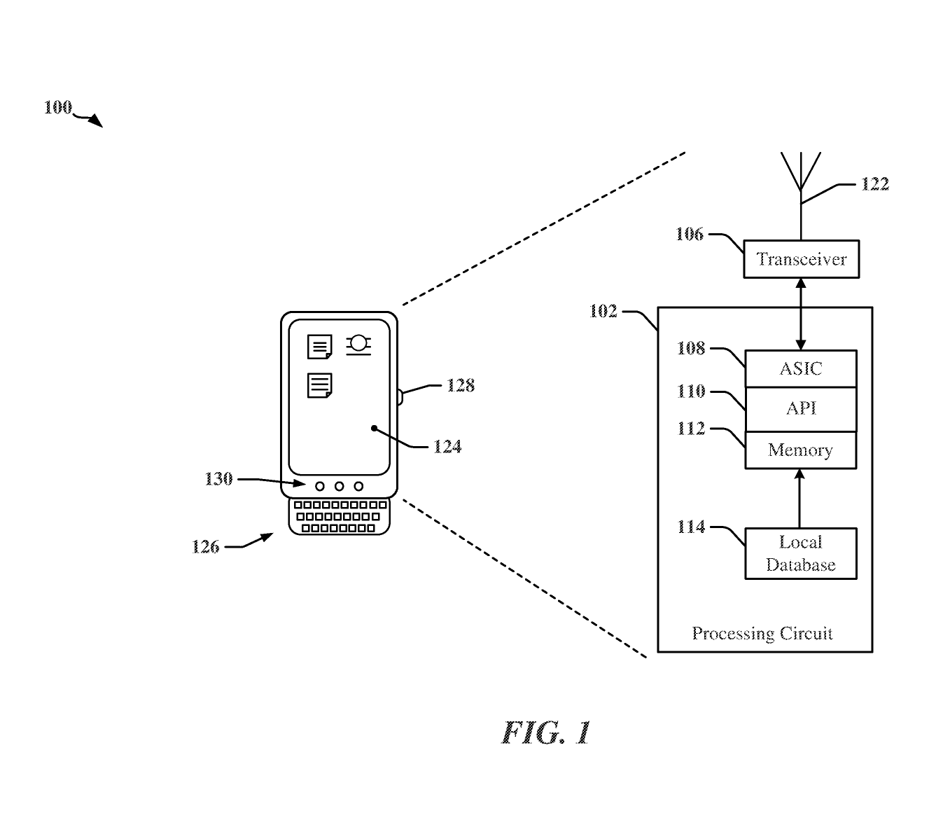

FIG. 1 depicts an apparatus 100 that may employ a communication link between IC devices. In one example, the apparatus 100 may include a communication device that communicates through a radio frequency (RF) communications transceiver 106 with a radio access network (RAN), a core access network, the Internet and/or another network. The communications transceiver 106 may be operably coupled to a processing circuit 102. The processing circuit 102 may include one or more IC devices, such as an application-specific IC (ASIC) 108. The ASIC 108 may include one or more processing devices, logic circuits, and so on. The processing circuit 102 may include and/or be coupled to processor readable storage such as a memory device 112 that can store and maintain data and instructions for execution or other use by the processing circuit 102. The processing circuit 102 may be controlled by one or more of an operating system and an application programming interface (API) 110 layer that supports and enables execution of software modules residing in storage media, such as the memory device 112 of the communication device. The memory device 112 may include ROM or RAM, EEPROM, flash cards, or any memory device that can be used in processing systems and computing platforms. The processing circuit 102 may include or access a local database 114 that can maintain operational parameters and other information used to configure and operate the apparatus 100. The local database 114 may be implemented using one or more of a database module, flash memory, magnetic media, EEPROM, optical media, tape, soft or hard disk, or the like. The processing circuit may also be operably coupled to external devices such as an antenna 122, a display 124, operator controls, such as a button 128 and a keypad 126 among other components.

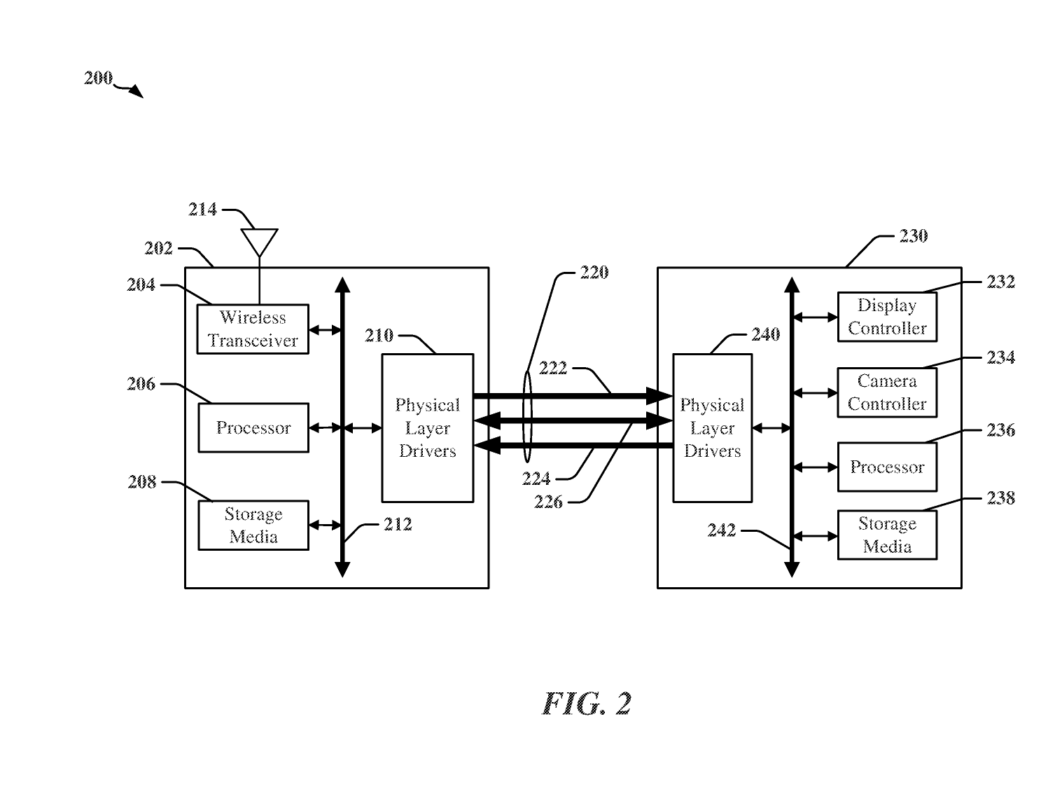

FIG. 2 is a block schematic diagram illustrating certain aspects of an apparatus 200 such as a mobile apparatus that employs a communication link 220 to connect various subcomponents. In one example, the apparatus 200 includes a plurality of IC devices 202 and 230 that exchange data and control information through the communication link 220. The communication link 220 may be used to connect IC devices 202 and 230 that are located in close proximity to one another, or physically located in different parts of the apparatus 200. In one example, the communication link 220 may be provided on a chip carrier, substrate or circuit board that carries the IC devices 202 and 230. In another example, a first IC device 202 may be located in a keypad section of a mobile computing device while a second IC device 230 may be located in a display section of mobile computing device. In another example, a portion of the communication link 220 may include a cable or optical connection.

The communication link 220 may provide multiple channels 222, 224 and 226. One or more channels 226 may be bidirectional, and may operate in half-duplex and/or full-duplex modes. One or more channels 222 and 224 may be unidirectional. The communication link 220 may be asymmetrical, providing higher bandwidth in one direction. In one example described herein, a first communications channel 222 may be referred to as a forward channel 222 while a second communications channel 224 may be referred to as a reverse channel 224. The first IC device 202 may be designated as a host system or transmitter, while the second IC device 230 may be designated as a client system or receiver, even if both IC devices 202 and 230 are configured to transmit and receive on the communications channel 222. In one example, the forward channel 222 may operate at a higher data rate when communicating data from a first IC device 202 to a second IC device 230, while the reverse channel 224 may operate at a lower data rate when communicating data from the second IC device 230 to the first IC device 202.

The IC devices 202 and 230 may each have a processor or other processing and/or computing circuit or device 206, 236. In one example, the first IC device 202 may perform core functions of the apparatus 200, including maintaining communications through a radio frequency transceiver 204 and an antenna 214, while the second IC device 230 may support a user interface that manages or operates a display controller 232. In the example, the second IC device 230 may be adapted to control operations of a camera or video input device using a camera controller 234. Other features supported by one or more of the IC devices 202 and 230 may include a keyboard, a voice-recognition component, and other input or output devices. The display controller 232 may include circuits and software drivers that support displays such as a liquid crystal display (LCD) panel, touch-screen display, indicators and so on. The storage media 208 and 238 may include transitory and/or non-transitory storage devices adapted to maintain instructions and data used by respective processors 206 and 236, and/or other components of the IC devices 202 and 230. Communication between each processor 206, 236 and its corresponding storage media 208 and 238 and other modules and circuits may be facilitated by one or more bus 212 and 242, respectively.

The reverse channel 224 may be operated in the same manner as the forward channel 222, and the forward channel 222 and reverse channel 224 may be capable of transmitting at comparable speeds or at different speeds, where speed may be expressed as data transfer rate and/or clocking rates. The forward and reverse data rates may be substantially the same or differ by orders of magnitude, depending on the application. In some applications, a single bidirectional channel 226 may support communications between the first IC device 202 and the second IC device 230. The forward channel 222 and/or reverse channel 224 may be configurable to operate in a bidirectional mode when, for example, the forward and reverse channels 222 and 224 share the same physical connections and operate in a half-duplex manner. In one example, the communication link 220 may be operated to communicate control, command and other information between the first IC device 202 and the second IC device 230 in accordance with an industry or other standard.

In some instances, the forward and reverse channels 222 and 224 may be configured or adapted to support a wide video graphics array (WVGA) 80 frames per second LCD driver IC without a frame buffer, delivering pixel data at 810 Mbps for display refresh. In another example, the forward and reverse channels 222 and 224 may be configured or adapted to enable communications between with dynamic random access memory (DRAM), such as double data rate synchronous dynamic random access memory (SDRAM). The drivers 210, 240 may include encoding devices that can be configured to encode multiple bits per clock transition, and multiple sets of wires can be used to transmit and receive data from the SDRAM, control signals, address signals, and other signals.

The forward and reverse channels 222 and 224 may comply with, or be compatible with application-specific industry standards. In one example, the MIPI standard defines physical layer interfaces between an application processor IC device 202 and an IC device 230 that supports the camera or display in a mobile device. The MIPI standard includes specifications that govern the operational characteristics of products that comply with MIPI specifications for mobile devices. In some instances, the MIPI standard may define interfaces that employ complimentary metal-oxide-semiconductor (CMOS) parallel busses.

The MIPI Alliance defines standards and specifications that may address communications affecting all aspects of operations in a mobile device, including the antenna, peripherals, the modem and application processors. For example, the MIPI Alliance defines protocols for a camera serial interface (CSI) and a display serial interface (DSI). The MIPI CSI-2 defines a wired interface between a camera and Application Processor and the MIPI DSI or DSI-2 defines a wired interface between an Application Processor and a display. The low-level physical layer (PHY) interface in each of these applications can be MIPI C-PHY or MIPI D-PHY.

MIPI C-PHY Interface

According to certain aspects disclosed herein, systems and apparatus may employ multi-phase data encoding and decoding interface methods for communicating between IC devices 202 and 230. A multi-phase encoder may drive a plurality of conductors (i.e., M conductors). The M conductors typically include three or more conductors, and each conductor may be referred to as a wire, although the M conductors may include conductive traces on a circuit board or within a conductive layer of a semiconductor IC device. In one example, the MIPI Alliance-defined “C-PHY” physical layer interface technology may be used to connect camera and display devices 230 to an application processor device 202. The C-PHY interface employs three-phase symbol encoding to transmit data symbols on 3-wire lanes, or “trios” where each trio includes an embedded clock.

The M conductors may be divided into a plurality of transmission groups, each group encoding a portion of a block of data to be transmitted. An N-phase encoding scheme is defined in which bits of data are encoded in phase transitions and polarity changes on the M conductors. Decoding does not rely on independent conductors or pairs of conductors and timing information can be derived directly from phase and/or polarity transitions in the M conductors. N-Phase polarity data transfer can be applied to any physical signaling interface, including electrical, optical and radio frequency (RF) interfaces.

In the C-PHY example, a three-phase encoding scheme for a three-wire system may define three phase states and two polarities, providing 6 states and 5 possible transitions from each state. Deterministic voltage and/or current changes may be detected and decoded to extract data from the three wires.

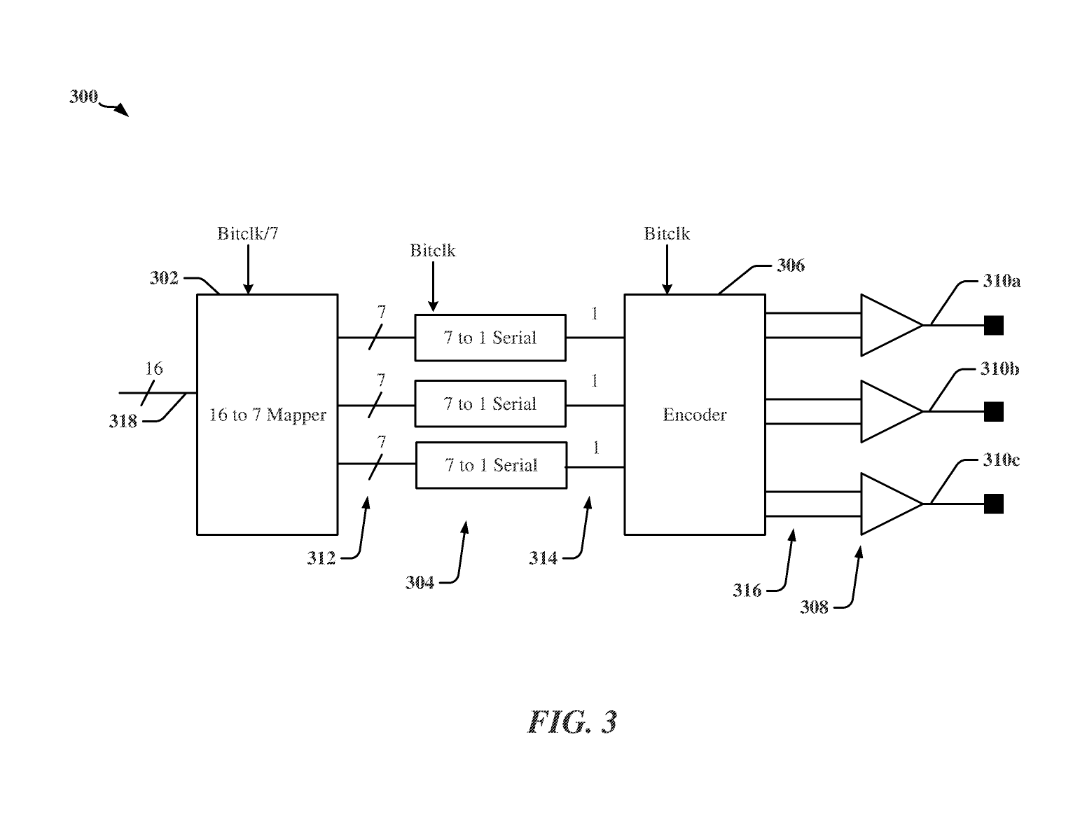

FIG. 3 is a schematic diagram illustrating the use of N-phase polarity encoding to implement certain aspects of the communication link 220 depicted in FIG. 2. The illustrated example may relate to a three-wire link or to a portion of a link that has more than three wires. The communication link 220 may include a wired bus having a plurality of signal wires, which may be configured to carry three-phase encoded data in a high-speed digital interface, such as a mobile display digital interface (MDDI). One or more of the channels 222, 224 and 226 may be configured or adapted to use three-phase polarity encoding. The physical layer drivers 210 and 240 may be adapted to encode and decode three-phase polarity encoded data transmitted on the communication link 220. The use of 3-phase polarity encoding provides for high-speed data transfer and may consume half or less of the power of other interfaces because fewer than 3 drivers are active in 3-phase polarity encoded data communication links 220 at any time. 3-phase polarity encoding circuits in the physical layer drivers 210 and/or 240 can encode multiple bits per transition on the communication link 220. In one example, a combination of three-phase encoding and polarity encoding may be used to support a wide video graphics array (WVGA), 80 frames per second LCD driver IC without a frame buffer, delivering pixel data for display refresh at 810 Mbps over three or more wires.

In the depicted C-PHY example 300, an M-wire, N-phase polarity encoding transmitter is configured for M=3 and N=3. The example of three-wire, three-phase encoding is selected solely for the purpose of simplifying descriptions of certain aspects of this disclosure. The principles and techniques disclosed for three-wire, three-phase encoders can be applied in other configurations of M-wire, N-phase polarity encoders, and may comply or be compatible with other interface standards.

When three-phase polarity encoding is used, connectors such as signal wires 310a, 310b and 310c on a 3-wire bus may be undriven, driven positive, or driven negative. An undriven signal wire 310a, 310b or 310c may be in a high-impedance state. An undriven signal wire 310a, 310b or 310c may be driven or pulled to a voltage level that lies substantially halfway between the positive and negative voltage levels provided on driven signal wires. An undriven signal wire 310a, 310b or 310c may have no current flowing through it. In the example 300, each signal wire 310a, 310b and 310c may be in one of three states (denoted as +1, −1, or 0) using drivers 308. In one example, drivers 308 may include unit-level current-mode drivers. In another example, drivers 308 may drive opposite polarity voltages on two signals transmitted on the signal wires 310a and 310b while the third signal wire 310c is at high impedance and/or pulled to ground. For each transmitted symbol interval, at least one signal is in the undriven (0) state, while the number of signals driven positive (+1 state) is equal to the number of signals driven negative (−1 state), such that the sum of current flowing to the receiver is always zero. For each symbol, the state of at least one signal wire 310a, 310b or 310c is changed from the symbol transmitted in the preceding transmission interval.

In the example, 300, a mapper 302 may receive 16-bit data 318, and the mapper 302 may map the input data 318 to 7 symbols 312 for transmitting sequentially over the signal wires 310a, 310b and 310c. An M-wire, N-phase encoder 306 configured for three-wire, three-phase encoding receives the 7 symbols 312 produced by the mapper 302 one symbol 314 at a time and computes the state of each signal wire 310a, 310b and 310c for each symbol interval, based on the immediately preceding state of the signal wires 310a, 310b and 310c. The 7 symbols 312 may be serialized using parallel-to-serial converters 304, for example. The encoder 306 selects the states of the signal wires 310a, 310b and 310c based on the next symbol 314 provided by the mapper 302 and the previous states of signal wires 310a, 310b and 310c.

The use of M-wire, N-phase encoding permits a number of bits to be encoded in a plurality of symbols where the bits per symbol is not an integer. In the simple example of a three-wire, three-phase system, there are 3 available combinations of 2 wires, which may be driven simultaneously, and 2 possible combinations of polarity on any pair of wires that is driven simultaneously, yielding 6 possible states. Since each transition occurs from a current state, 5 of the 6 states are available at every transition. The state of at least one wire is typically required to change at each transition. With 5 states, log₂(5)≅2.32 bits may be encoded per symbol. Accordingly, a mapper may accept a 16-bit word and convert it to 7 symbols because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

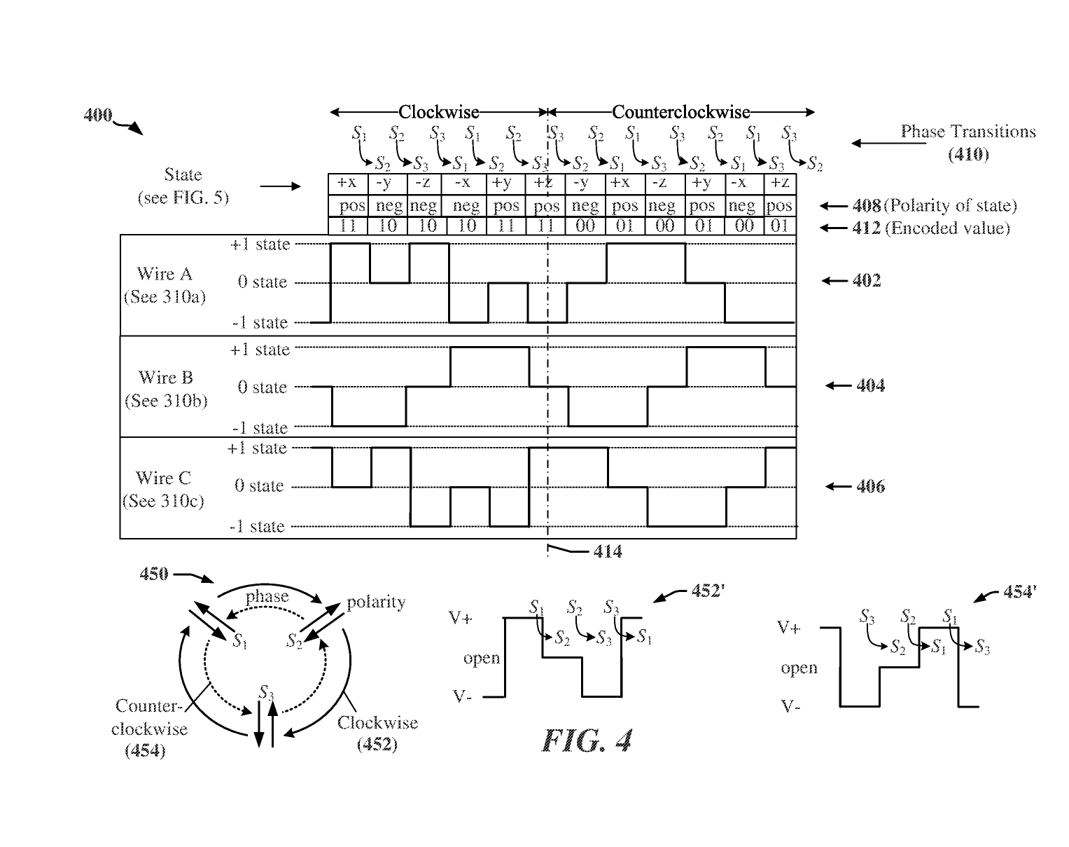

FIG. 4 illustrates an example of signaling 400 employing a three-phase modulation data-encoding scheme based on the circular state transition diagram 450. According to the data-encoding scheme, a three-phase signal may rotate in two directions and may be transmitted on three signal wires 310a, 310b and 310c. Each of the three signals is independently driven on the signal wires 310a, 310b, 310c. Each of the three signals includes the three-phase signal, with each signal being 120 degrees out of phase relative to the other two signals. At any point in time, each of the three signal wires 310a, 310b, 310c is in a different one of the states {+1, 0, −1}. At any point in time, each of the three signal wires 310a, 310b, 310c in a 3-wire system is in a different state than the other two wires. When more than three conductors or wires are used, two or more pairs of wires may be in the same state. The illustrated encoding scheme may also encode information in the polarity of the two signal wires 310a, 310b and/or 310c that are actively driven to the +1 and −1 states. Polarity is indicated at 408 for the sequence of states depicted.

At any phase state in the illustrated three-wire example, exactly two of the signal wires 310a, 310b, 310c carry a signal which is effectively a differential signal for that phase state, while the third signal wire 310a, 310b or 310c is undriven. The phase state for each signal wire 310a, 310b, 310c may be determined by voltage difference between the signal wire 310a, 310b or 310c and at least one other signal wire 310a, 310b and/or 310c, or by the direction of current flow, or lack of current flow, in the signal wire 310a, 310b or 310c. As shown in the state transition diagram 450, three phase states (S₁, S₂ and S₃) are defined. A signal may flow clockwise from phase state S₁ to phase state S₂, phase state S₂ to phase state S₃, and/or phase state S₃ to phase state S₁ and the signal may flow counter-clockwise from phase state S₁ to phase state S₃, phase state S₃ to phase state S₂, and/or phase state S₂ to phase state S₁. For other values of N, transitions between the N states may optionally be defined according to a corresponding state diagram to obtain circular rotation between state transitions.

In the example of a three-wire, three-phase communications link, clockwise rotations (S₁ to S₂), (S₂ to S₃), and/or (S₃ to S₁) at a state transition 410 may be used to encode a logic 1, while counter-clockwise rotations (S₁ to S₃), (S₃ to S₂), and/or (S₂ to S₁) at the state transition 410 may be used to encode a logic 0. Accordingly, a bit may be encoded at each transition by controlling whether the signal is “rotating” clockwise or counter-clockwise. For example, a logic 1 may be encoded when the three signal wires 310a, 310b, 310c transition from phase state S₁ to phase state S₂ and a logic 0 may be encoded when the three signal wires 310a, 310b, 310c transition from phase state S₁ to phase state S₃. In the simple three-wire example depicted, direction of rotation may be easily determined based on which of the three signal wires 310a, 310b, 310c is undriven before and after the transition.

Information may also be encoded in the polarity and/or changes of polarity of state 408 of the driven signal wires 310a, 310b, 310c, or in the direction of current flow or changes in the direction of current flow between two signal wires 310a, 310b, 310c. Signals 402, 404, and 406 illustrate voltage levels applied to signal wires 310a, 310b, 310c, respectively at each phase state in a three-wire, three-phase link At any time, a first signal wire 310a, 310b, 310c is coupled to a more positive voltage (+V, for example), a second signal wire 310a, 310b, 310c is coupled to a more negative voltage (−V, for example), while the third signal wire 310a, 310b, 310c may be open-circuited. As such, one polarity encoding state may be determined by the current flow between the first and second signal wires 310a, 310b, 310c or the voltage polarities of the first and second signal wires 310a, 310b, 310c. In some embodiments, two bits of data 412 may be encoded in each state transition 410. A decoder may determine the direction of signal phase rotation to obtain the first bit. The second bit may be determined based on the polarity difference between two of the signals 402, 404 and 406. In some instances, the second bit may be determined based on a change or lack of change in polarity of the differential signal transmitted on a pair of the signal wires 310a, 310b, 310c. The decoder having determined direction of rotation can determine the phase state and the polarity of the voltage applied between the two active signal wires 310a, 310b and/or 310c, or the direction of current flow through the two active signal wires 310a, 310b and/or 310c.

In the example of the three-wire, three-phase link described herein, one bit of data may be encoded in the rotation, or phase change in the three-wire, three-phase link, and an additional bit may be encoded in the polarity or changes in polarity of two driven wires. Certain embodiments, encode more than two bits in each transition of a three-wire, three-phase encoding system by allowing transition to any of the possible states from a current state. Given three rotational phases and two polarities for each phase, 6 states are defined, such that 5 states are available from any current state. Accordingly, there may be log₂(5)≅2.32 bits per symbol (transition) and the mapper may accept a 16-bit word and convert it to 7 symbols.

In one example, an encoder may transmit symbols using 6 wires with two pairs of wires driven for each state. The 6 wires may be labeled A through F, such that in one state, wires A and F are driven positive, wires B and E negative, and C and D are undriven (or carry no current). For six wires, there may be:

$$C ( 6 , 4 ) = \frac{6 !}{( 6 - 4 ) ! \cdot 4 !} = 15$$

possible combinations of actively driven wires, with:

$$C ( 4 , 2 ) = \frac{4 !}{( 4 - 2 ) ! \cdot 2 !} = 6$$

different combinations of polarity for each phase state.

The 15 different combinations of actively driven wires may include:

| | | | | |
|---|---|---|---|---|
| A B C D | A B C E | A B C F | A B D E | A B D F |
| A B E F | A C D E | A C D F | A C E F | A D E F |
| B C D E | B C D F | B C E F | B D E F | C D E F |

Of the 4 wires driven, the possible combinations of two wires driven positive (and the other two must be negative). The combinations of polarity may include:
++−− +−−+ +−+− −+−+ −++− −−++

Accordingly, the total number of different states may be calculated as 15×6=90. To guarantee a transition between symbols, 89 states are available from any current state, and the number of bits that may be encoded in each symbol may be calculated as: log₂(89)≅6.47 bits per symbol. In this example, a 32-bit word can be encoded by the mapper into 5 symbols, given that 5×6.47=32.35 bits.

The general equation for the number of combinations of wires that can be driven for a bus of any size, as a function of the number of wires in the bus and number of wires simultaneously driven:

$$C ( {N}_{wires} , {N}_{driven} ) = \frac{{N}_{wires} !}{( {N}_{wires} - {N}_{driven} ) ! \cdot {N}_{driven} !}$$

The equation for the number of combinations of polarity for the wires being driven is:

$$C ( {N}_{driven} , \frac{{N}_{driven}}{2} ) = \frac{{N}_{driven} !}{{( ( \frac{{N}_{driven}}{2} ) ! )}^{2}}$$

The number of bits per symbol is:

$${log}_{2} ( C ( {N}_{wires} , {N}_{driven} ) \cdot C ( {N}_{driven} , \frac{{N}_{driven}}{2} ) - 1 ) .$$

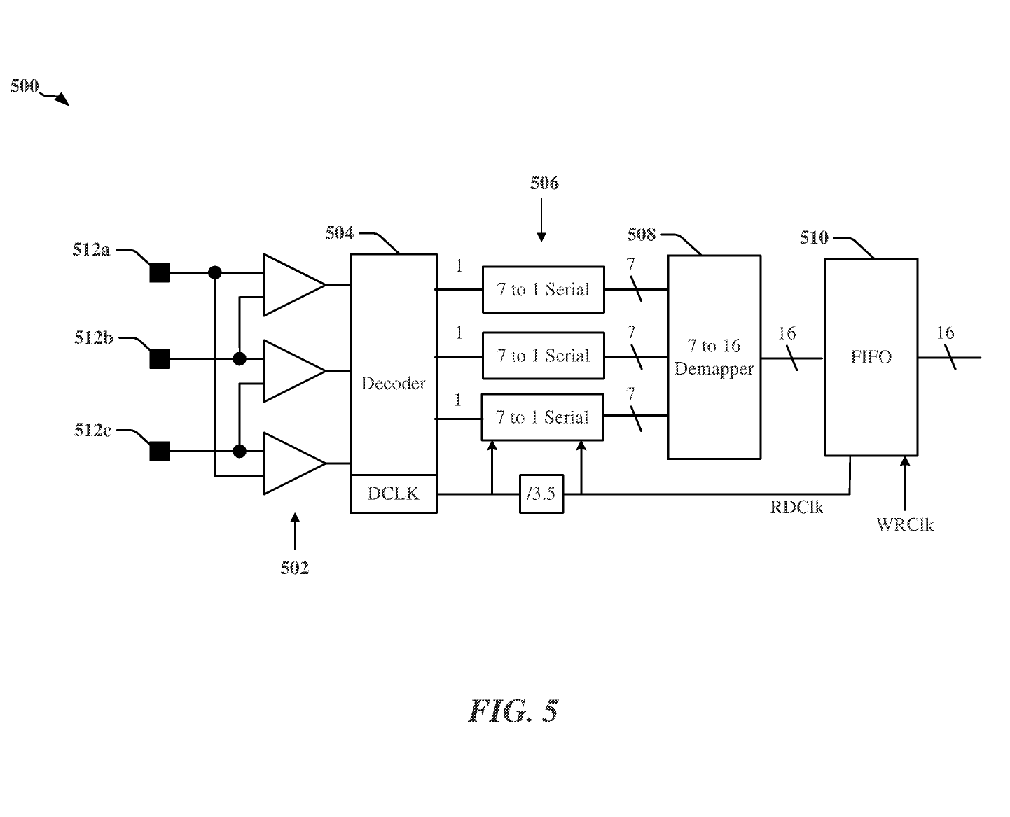

FIG. 5 illustrates an example 500 of a receiver in a three-wire, three-phase PHY. The three-wire, three-phase example is illustrative of certain principles of operation applicable to other configurations of M-wire, N-phase receivers. Comparators 502 and decoder 504 are configured to provide a digital representation of the state of each of three transmission lines 512a, 512b and 512c, as well as the change in the state of the three transmission lines compared to the state transmitted in the previous symbol period. Seven consecutive states are assembled by serial-to-parallel convertors 506 to produce a set of 7 symbols to be processed by demapper 508 to obtain 16 bits of data that may be buffered in a first-in-first-out (FIFO) storage device 510, which may be implemented using registers, for example.

According to certain aspects disclosed herein, a plurality of three-state amplifiers can be controlled to produce a set of output states defined by a differential encoder, an N-phase polarity encoder, or another encoder that encodes information in wires or connectors that can assume one of the three states described.

With reference again to FIGS. 2 and 3, the communication link 220 may include a high-speed digital interface that can be configured to support both differential encoding scheme and N-phase polarity encoding. Physical layer drivers 210 and 240 may include N-phase polarity encoders and decoders, which can encode multiple bits per transition on the interface, and line drivers to drive signal wires 310a, 310b and 310c. The line drivers may be constructed with amplifiers that produce an active output that can have a positive or negative voltage, or a high impedance output whereby a signal wire 310a, 310b or 310c is in an undefined state or a state that is defined by external electrical components. Accordingly, the output drivers 308 may receive by a pair of signals 316 that includes data and output control (high-impedance mode control). In this regard, the three-state amplifiers used for N-phase polarity encoding and differential encoding can produce the same or similar three output states.

MIPI D-PHY Interface

According to certain aspects disclosed herein, systems and apparatus may employ some combination of differential and single-ended encoding for communicating between IC devices 202 and 230. In one example, the MIPI Alliance-defined “D-PHY” physical layer interface technology may be used to connect camera and display devices 230 to an application processor device 202. The D-PHY interface can switch between a differential (High-speed) mode and a single-ended (Low Power) mode in real time as needed to facilitate the transfer of large amounts of data or to conserve power and prolong battery life. The D-PHY interface is capable of operating in simplex or duplex configuration with single data lane or multiple data lanes with a unidirectional (Master to Slave) clock lane.

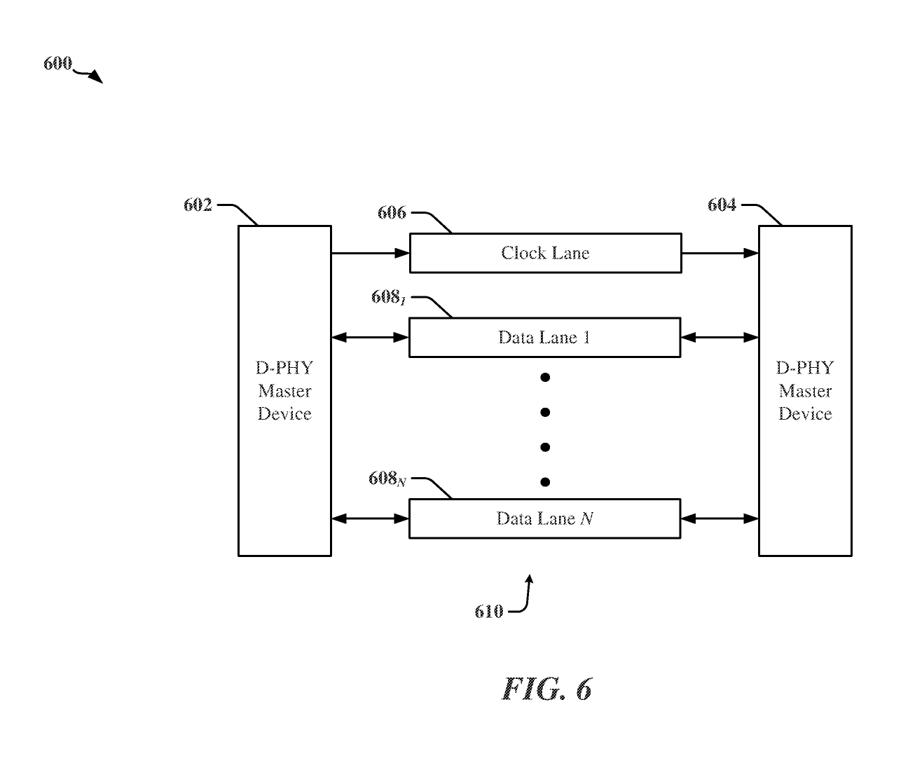

FIG. 6 illustrates a generalized D-PHY configuration 600 that includes a master device 602 and a slave device 604. The master device 602 generates clock signals that control transmissions on the wires 610. A clock signal is transmitted on a clock lane 606 and data is transmitted in one or more data lanes 608₁-608_{N}. The number of data lanes 608₁-608_{N} that are provided or active in a device may be dynamically configured based on application needs, volumes of data to be transferred and power conservation needs.

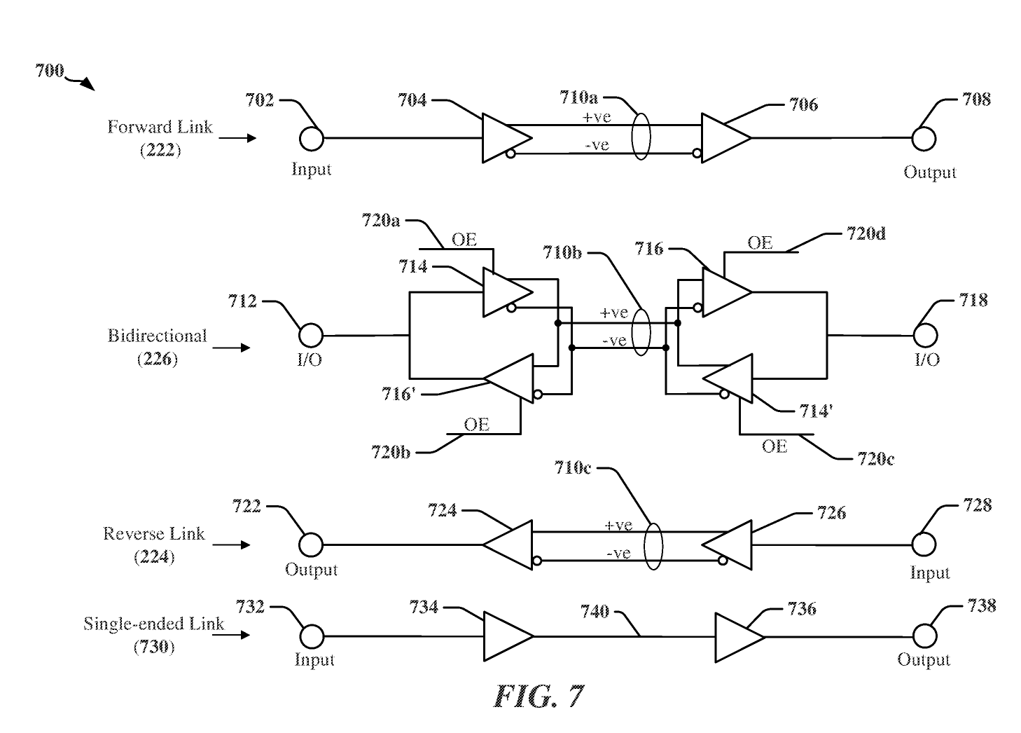

FIG. 7 is a schematic diagram 700 illustrating differential signaling lanes that may be employed when a D-PHY implementation of the communication link 220 (see FIG. 2) is operated in High-speed mode. Differential signaling typically involves transmitting information electrically using two complementary signals sent on a pair of wires 710a, 710b or 710c, which may be referred to as a differential pair. The use of differential pairs can significantly reduce electromagnetic interference (EMI) by canceling the effect of common-mode interference that affects both wires in a differential pair. On the forward channel 222, a pair of wires 710a may be driven by a host differential driver 704. The differential driver 704 receives an input data stream 702 and generates positive and negative versions of the input data stream 702, which are then provided to the pair of wires 710a. The differential receiver 706 on the client side generates an output data stream 708 by performing a comparison of the signals carried on the pair of wires 710a.

On the reverse channel 224, one or more pairs of wires 710c may be driven by a client-side differential driver 726. The differential driver 726 receives an input data stream 728 and generates positive and negative versions of the input data stream 728, which are provided to the pair of wires 710c. The differential receiver 724 on the host generates an output data stream 722 by performing a comparison of the signals carried on the pair of wires 710c.

In a bidirectional channel 226, the host and client may be configured for half-duplex mode and may transmit and receive data on the same pair of wires 710b. A bidirectional bus may alternatively or additionally be operated in full-duplex mode using combinations of the forward and reverse link differential drivers 704, 726 to drive multiple pairs of wires 710a, 710c. In the half-duplex bidirectional implementation depicted for the bidirectional channel 226, the differential drivers 714 and 714′ may be prevented from driving the pair of wires 710b simultaneously using, for example, an output enable (OE) control 720a, 720c (respectively) to force the differential drivers 714 and 714′ into a high impedance state. The differential receiver 716′ may be prevented from driving the input/output 712 while the differential driver 714 is active, typically using an OE control 720b to force the differential receiver 716′ into a high impedance state. The differential receiver 716 may be prevented from driving the input/output 718 while the differential driver 714′ is active, typically using an OE control 720d to force the differential receiver 716 into a high impedance state. In some instances, the outputs of the differential drivers 714 and 714′ and the differential receivers 716 and 716′ may be in a high-impedance state when the interface is not active. Accordingly, the OE controls 720a, 720c, 720b and 720c of the differential drivers 714, 714′, and the differential receivers 716 and 716′ may be operated independently of one another.

Each of the differential drivers 704, 714, 714′ and 726 may include a pair of amplifiers, one receiving at one input the inverse of the input of the other amplifier. The differential drivers 704, 714, 714′ and 726 may each receive a single input and may have an internal inverter that generates an inverse input for use with a pair of amplifiers. The differential drivers 704, 714, 714′ and 726 may also be constructed using two separately controlled amplifiers, such that their respective outputs can be placed in high impedance mode independently of one another.

When a D-PHY implementation of the communication link 220 (see FIG. 2) is operated in Low Power mode, signals may be transmitted on single wire data and/or clock lanes. In one example, the differential drivers 704, 714, and/or 726 may be reconfigured or controlled such that only one of the wires in a pair of wires 710a, 710b or 710c of an active lane is driven. In other examples, the differential drivers 704, 714, and/or 726 may be turned off or placed in a high-impedance output mode, and separate, single-ended line driver 734 and receiver 736 may be used for communications over a single-wire, single-ended link 740. In some instances, the input 732 and output 738 of the single-ended link 740 may be bidirectional, and both transmitting and receiving devices may employ a transceiver that includes both a line driver 734 and a receiver 736 that is controlled in accordance with one or more protocols.

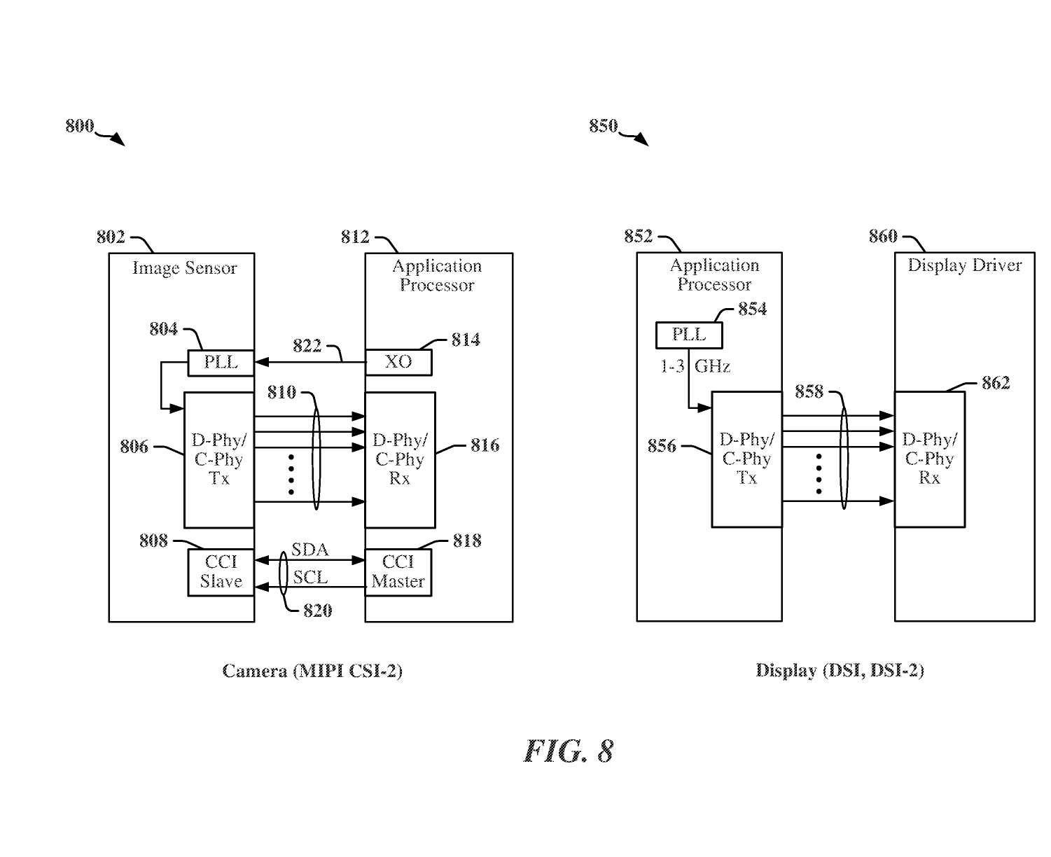

FIG. 8 illustrates certain interface configurations associated with a camera subsystem 800 and a display subsystem 850 that may be deployed within a mobile device, for example. The camera subsystem 800 may include a CSI-2 defined communication link between an image sensor 802 and an application processor 812. The communication link may include a high-data rate data transfer link 810 used by the image sensor 802 to transmit image data to the application processor 812 using a transmitter 806. The high-data rate data transfer link 810 may be configured and operated according to D-PHY or C-PHY protocols. The application processor 812 may include a crystal oscillator (XO) 814 or other clock source to generate a clock signal 822 that controls the operation of the transmitter 806. The clock signal 822 may be processed by a phase-locked loop (PLL) 804 in the image sensor 802. In some instances, the clock signal 822 may also be used by the D-PHY or C-PHY receiver 816 in the application processor 812. The communication link may include a Camera Control Interface (CCI), which is similar in nature to the Inter-Integrated Circuit (I2C) interface. The CCI bus may include Serial Clock (SCL) line that carries a clock signal and a Serial Data (SDA) line that carries data. The CCI link 820 may be bidirectional and may operate at a lower data rate than the high-data rate data transfer link 810. The CCI link 820 may be used by the application processor 812 to transmit control and data information to the image sensor 802 and to receive control and configuration information from the image sensor 802. The application processor 812 may include a CCI bus master 818 and the image sensor 802 may include a CCI slave 808.

The display subsystem 850 may include a unidirectional data link 858, which may be configured and operated according to D-PHY or C-PHY protocols. In the application processor 852, a clock source such as the PLL 854 may be used to generate a clock signal for controlling transmissions on the data link 858. At the display driver 860, a D-PHY or C-PHY receiver 862 may extract embedded clock information from sequences of symbols transmitted on the data link, or from a clock lane provided in the data link 858.

Devices adapted according to certain aspects disclosed herein may resolve issues arising from the complexities and hindrances associated with the use of optical media to extend the length of communication links that compliant or compatible with MIPI standards. Certain aspects disclosed herein relate to systems, apparatus and methods that support a broad range of interface protocols, and that can operate using different physical media. As shown in FIG. 8, for example, the camera subsystem 800 and/or display subsystem 850 may communicate high data rate information using D-PHY or C-PHY protocols and, in some configurations, may communicate using a reverse channel (e.g. the CCI link 820) for configuration of an image sensor 802 or other device. In some instances, a low power mode of operation may be defined for links that use either D-PHY or C-PHY protocols. Optical interfaces may be unsuited for low-power modes of operation, and the use of optical media to extend transmission distances can increase power consumption of a communications link. Optical interfaces are typically unidirectional. Although multiple channels may be multiplexed for transmission over the optical media in unidirectional transmissions, two optical links may be required to support bidirectional communication links.

Signaling Levels in C-PHY and D-PHY Interfaces

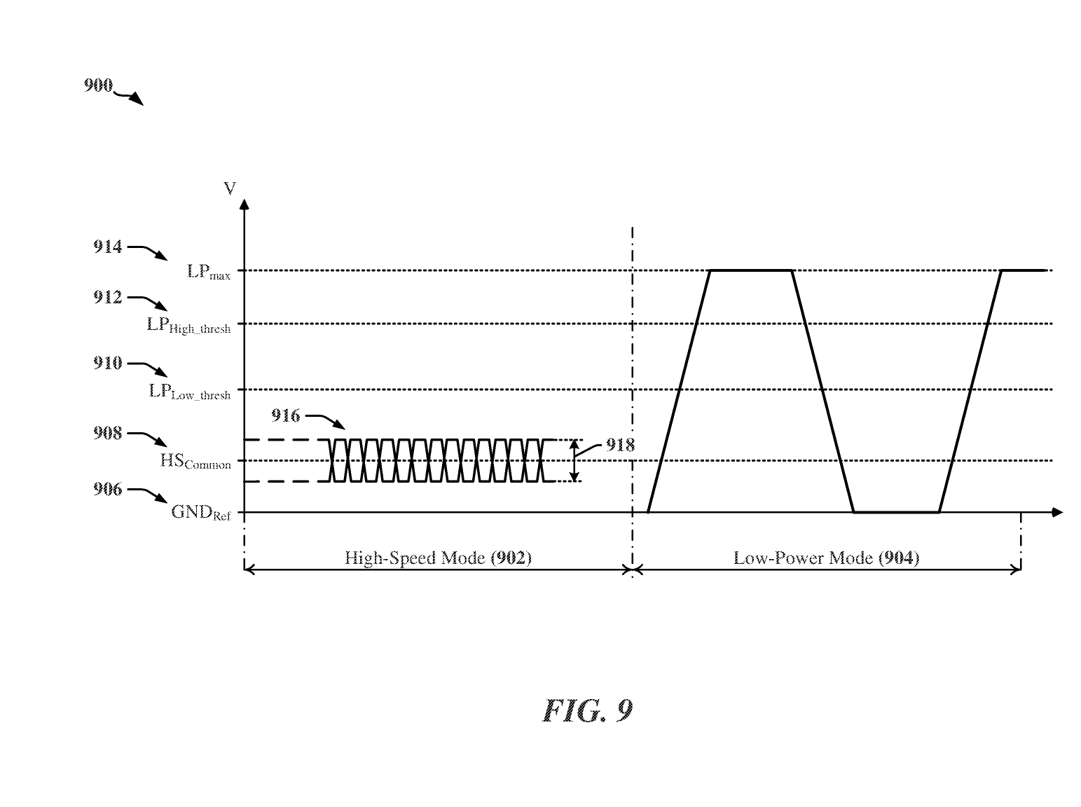

FIG. 9 is a graphical representation 900 of waveforms illustrating certain aspects of signaling in D-PHY and C-PHY interfaces. The D-PHY and C-PHY interfaces support a high-speed communication mode 902 and a low-power communication mode 904. Data is transmitted at a significantly lower rate in the low-power communication mode 904 than in the high-speed communication mode 902. The high-speed communication mode 902 and the low-power communication mode 904 operate at different voltage levels and voltage ranges when transmitting signal using the same wires of a serial bus.

In the high-speed communication mode 902, signals are centered on a high-speed common (HS_{Common}) voltage level 908, which is offset from a reference ground voltage level 906. Signals in the high-speed communication mode 902 have a voltage range 918 that ensures that high-speed signals 916 do not exceed a logic low threshold voltage level (LP_{Low}_{_}ₜₕᵣₑₛₕ) 910, which defines the upper limit for logic low in the low-power communication mode 904. In one D-PHY example, the HS_{Common} voltage level 908 may be nominally defined to be 200 millivolts (mV), and the voltage range 918 for high-speed signals may be nominally defined to be 200 mV. In one C-PHY example, the HS_{Common} voltage level 908 may be nominally defined to be 250 millivolts (mV), and the voltage range 918 for high-speed signals may be nominally defined to be 250 mV.

In the low-power communication mode 904, signals switch between a maximum low-power (LPₘₐₓ) voltage level 914 and the reference ground voltage level 906. The logic low voltage levels LP_{Low}_{_}ₜₕᵣₑₛₕ 910 and the logic high threshold voltage level (LP_{High}_{_}ₜₕᵣₑₛₕ) 912 define the switching voltage levels for high-to-low transitions and low-to high transitions, respectively. In one example, the maximum low-power (LPₘₐₓ) voltage level 914 may be nominally defined at 1.2 Volts (V).

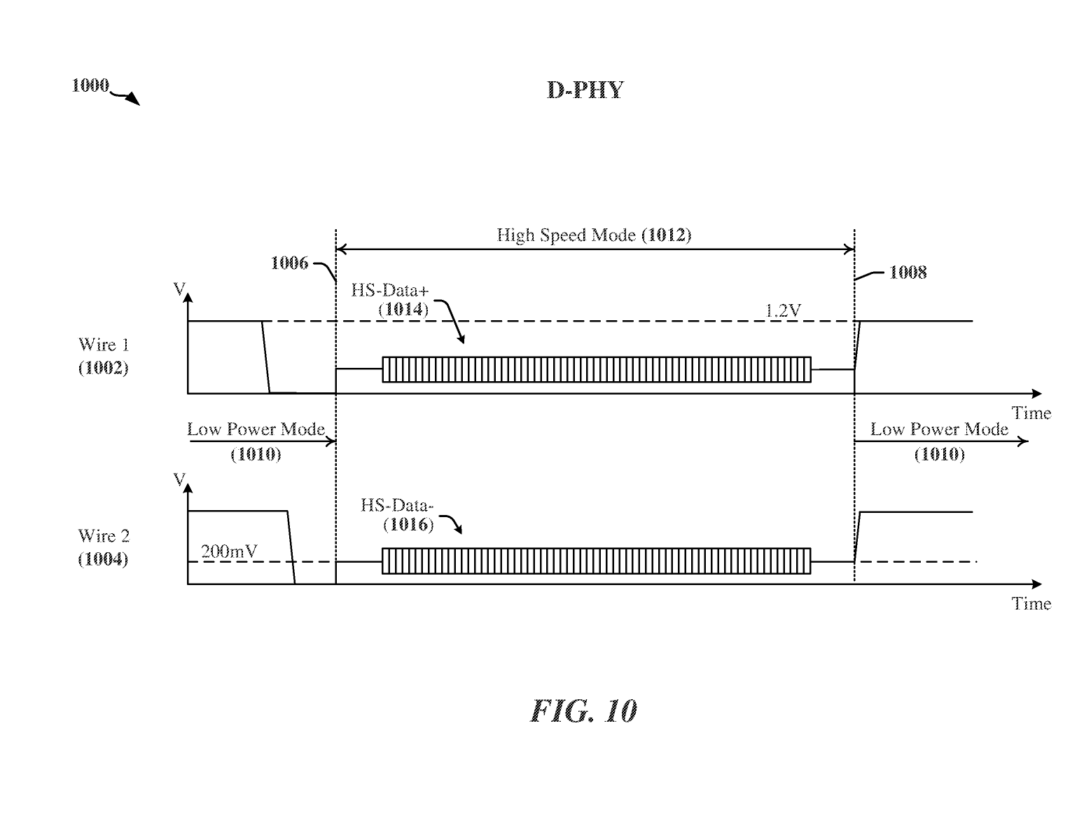

FIG. 10 is a graphical representation 1000 of waveforms illustrating transitions between communication modes using an example of a D-PHY interface. The example relates to two wires 1002, 1004 of a clock or data lane of a communication link The D-PHY interface may be configured to operate in a low-power mode 1010 and/or a high-speed mode 1012. In the low-power mode 1010, a first wire carries data signals at a relatively low data rate and with a voltage level swing of approximately 1.2 volts. In the high-speed mode 1012, the first and second wires 1002, 1004 carry a low-voltage differential signal that may have a data rate that is orders of magnitude faster than the data rate of the low-power mode 1010. For example, the low-power mode 1010 may support data rates up to 10 megabits per second (Mbps) while the high-speed mode 1012 may support data rates that lie between 90 Mbps and 1 gigabit per second (Gbps). The positive version of the differential signal may be carried on the first wire 1002, while the negative version is carried on the second wire 1004, in the high-speed mode 1012. The differential signal may have a relatively low amplitude voltage swing, which in one example may be approximately 200 millivolts (mV).

Packet Structure in CSI-2 C-PHY and D-PHY Interfaces

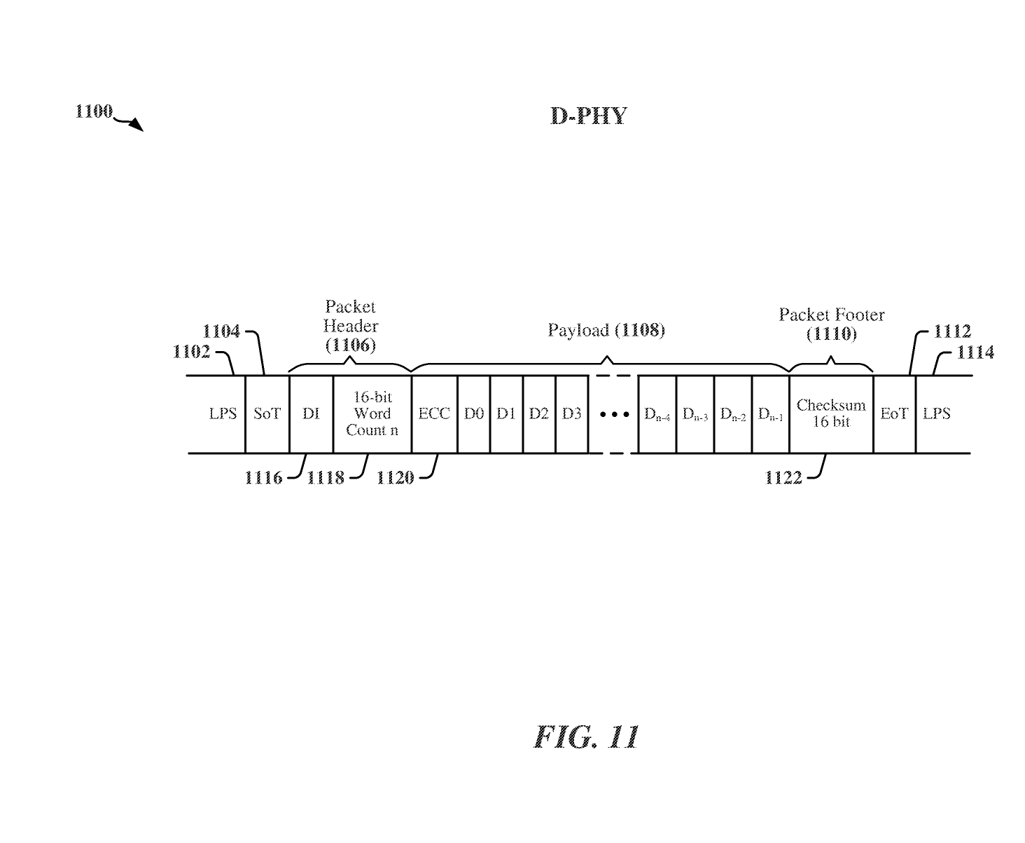

FIG. 11 is a timing diagram 1100 illustrating certain aspects of a data packet on a D-PHY interface. The D-PHY interface may initially be in a low-power state (LPS) 1102. A Start of Transmission (SoT) code 1104 may be transmitted to transition the D-PHY interface to a high-speed state. A packet header 1106 is transmitted. The packet header 1106 includes a data identifier (DI) 1116 that provides a virtual channel identifier and Data Type information, which may denote the format and/or content of the application specific payload data 1108 transmitted in the packet. The packet header 1106 includes a 16-bit value that provides a word count 1118, which identifies the size (‘n’) of the payload data 1108. A receiver may use the word count 1118 to determine the end of the packet. The packet header 1106 includes an error correction code (ECC) 1120 for the packet header 1106. The ECC 1120 enables detection of two bit errors and correction of one bit error. After the payload data 1108, 16-bit checksum or cyclic redundancy check (CRC) code 1122 for the packet is transmitted in a packet footer 1110 is transmitted. An end of transmission (EoT) code 1112 may be transmitted to return the D-PHY interface to a low-power state 1114.

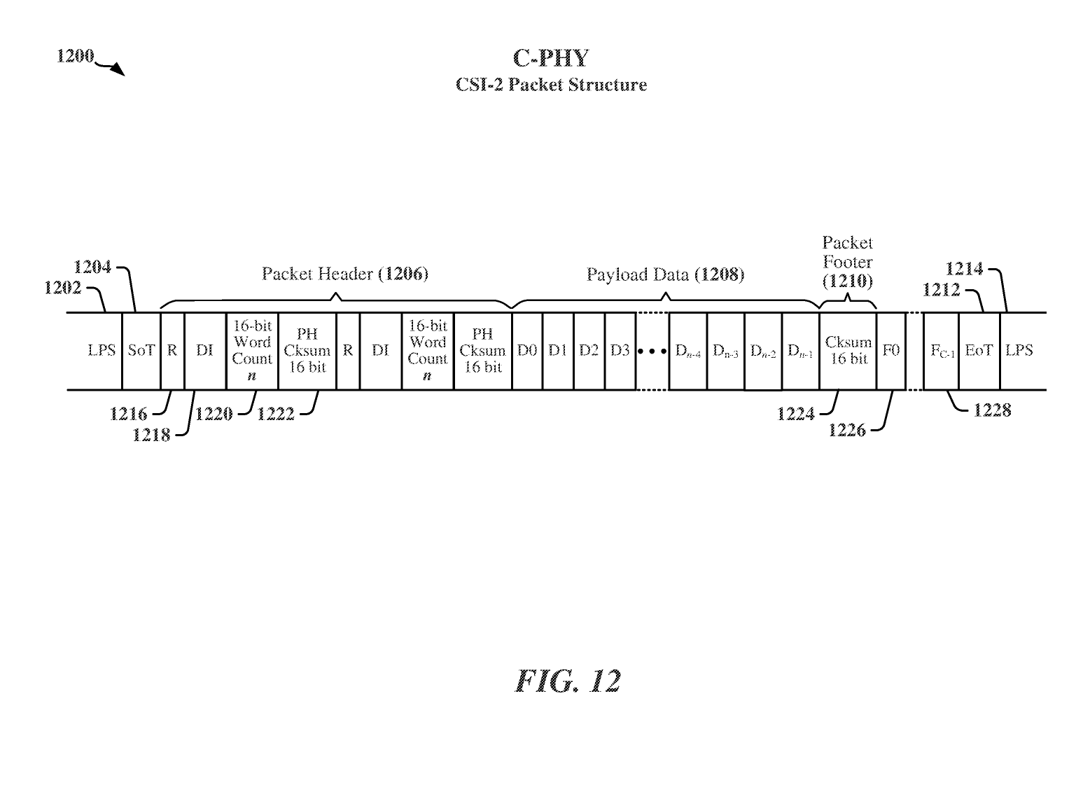

FIG. 12 is a diagram illustrating certain aspects of a CSI-2 packet structure 1200 used for transmitting data packet through a C-PHY interface. The C-PHY interface may initially be in a low-power state (LPS) 1202. Start of transmission (SoT 1204) may be signaled in order to transition the C-PHY interface to a high-speed state. A packet header 1206 is transmitted. The packet header 1206 may include a zero-value reserved word 1216 followed by a data identifier (DI) 1218 that provides a virtual channel identifier and Data Type information, which may denote the format and/or content of the application specific payload data 1208 transmitted in the packet. The packet header 1206 includes a 16-bit value that provides a word count 1220, which identifies the size (‘n’) of the payload data 1208. A receiver may use the word count 1220 to determine the end of the payload data 1208. The packet header 1206 includes a CRC code 1222 that is computed over the reserved word 1216, the DI 1218, the word count 1220 in the packet header 1206. The CRC code 1222 enables correction of multiple bit errors. A command may be inserted after the CRC code 1222 to cause the PHY to insert a Sync Word. The reserved word 1216, the DI 1218, the word count 1220 and the CRC code 1222 are retransmitted to complete transmission of the packet header 1206. The payload data 1208 is transmitted, followed by a CRC code that is computed over the payload data 1208. A packet header 1206 is transmitted on each lane of a multi-lane C-PHY interface. Different lanes may include different-sized payload data 1208 and one or more bytes 1226, 1228 may be transmitted to ensure that all lanes transport the same number of 16-bit words. An end of transmission (EoT) code 1212 may be transmitted to return the C-PHY interface to a low-power state 1214.

The C-PHY interface effectively transmits duplicate information in the packet header 1206 to assist in detection of symbol transmission errors. One symbol error in a C-PHY may result in a multi-bit burst error after decoding, due to the nature of transition encoding. At each symbol transmission boundary, a transmission symbol is selected based on the output of the mapper and the value of the preceding symbol. A symbol error may result in a decoding error at each boundary between the preceding and succeeding errors. An ECC that can correct only one bit error does not protect a mission critical packet header. Therefore, the illustrated MIPI CSI-2 long packet for C-PHY transmits a duplicate packet header and CRC codes are used for error detection in each copy of the packet header.

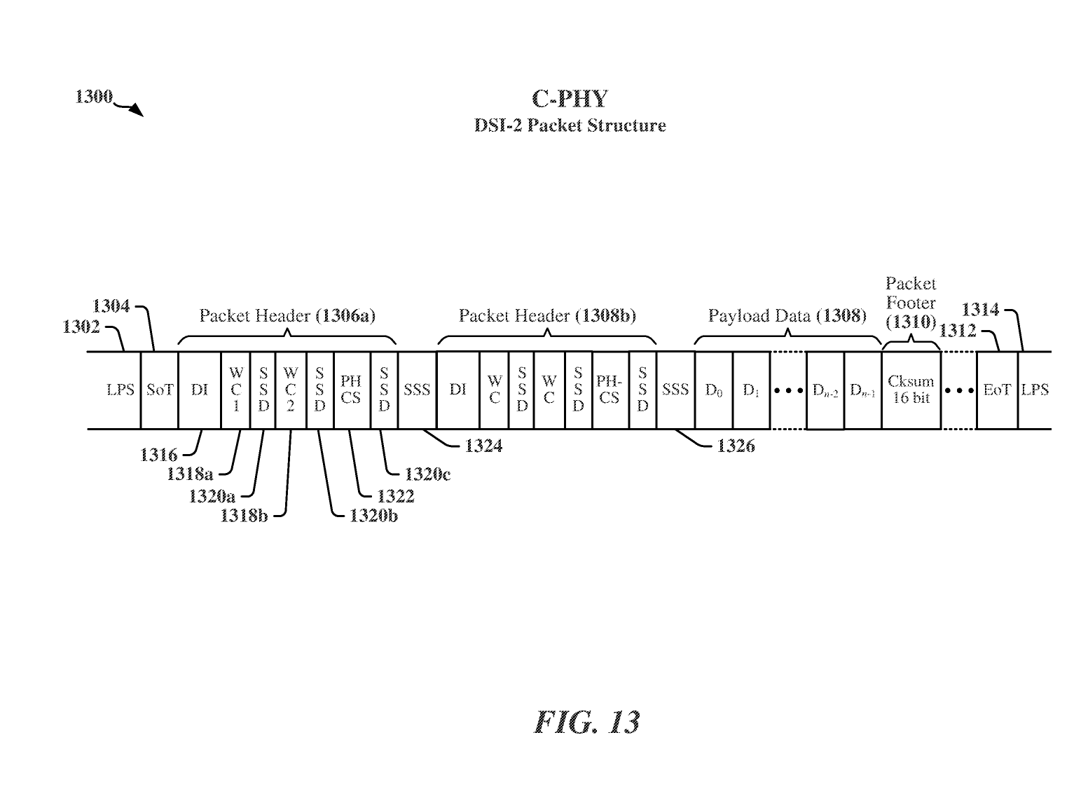

FIG. 13 is a diagram illustrating certain aspects of a DSI-2 packet structure 1300 used for transmitting data packet through a C-PHY interface. The C-PHY interface may initially be in a low-power state (LPS) 1302. A Start of Transmission (SoT 1304) may be signaled to transition the C-PHY interface to a high-speed state. The SoT 1304 terminates with a sync symbol sequence before a first copy of a packet header 1306a is transmitted. A second copy of the packet header 1306b is transmitted after the first copy of the packet header 1306a. A sync symbol sequence (SSS 1324) is transmitted between the first copy of the packet header 1306a and the second copy of the packet header 1306b. The second copy of the packet header 1306b is a repeat transmission of the first copy of the packet header 1306b. The first copy of the packet header 1306a may include a data identifier (DI 1316) that includes a virtual channel identifier and data type information, which may denote the format and/or content of the application specific payload data 1308 transmitted in the packet. The first copy of the packet header 1306a includes a 16-bit value that provides a word count transmitted in two fields (WC1 1318aand WC2 1318b). The word count conveys the size (‘n’) of the payload data 1308. A receiver may use the word count to determine the end of the payload data 1308. A symbol slip detection code (SSD 1320a, 1320b, 1320c) is transmitted to enable detection of symbol slip on a 16-bit word basis. A packet header checksum (PH-CS 1322) is included in the first copy of the packet header 1306a. The PH-CS 1322 may be computed as a CRC code that is computed over the DI 1316, WC1 1318a, WC2 1318b, SSD 1320a, 1320b and 1320c. The PH-CS 1322 enables detection of multiple bit errors. The first copy of the packet header 1306a is followed by SSS 1324. The SSS 1324 may be repeated a number of times, where the number of repetitions corresponds to the number of lanes.

Another sync symbol sequence (SSS 1326) is transmitted after the second copy of the packet header 1306b. The SSS 1326 may be repeated a number of times, where the number of repetitions corresponds to the number of lanes. The payload data 1308 is then transmitted, followed by a packet footer 1310 that includes a checksum code. An end of transmission (EoT) code 1312 may be transmitted to return the C-PHY interface to a low-power state 1314.

The C-PHY interface effectively transmits duplicate information in the packet header 1306 to assist in detection of symbol transmission errors. One symbol error in a C-PHY may result in a multi-bit burst error after decoding, due to the nature of transition encoding. At each symbol transmission boundary, a transmission symbol is selected based on the output of the mapper and the value of the preceding symbol. A symbol error may result in a decoding error at each boundary between the preceding and succeeding errors. An ECC that can correct only one-bit error does not protect a mission critical packet header. Therefore, the illustrated MIPI DSI-2 long packet for C-PHY transmits a duplicate packet header and CRC codes are used for error detection in each copy of the packet header.

Multiple Sync Word Types for C-PHY Interfaces

According to certain aspects disclosed herein, different Sync Word values can be used in a C-PHY interface. The Sync Word values can be used by a transmitter to signal information related to information transmitted after a sync symbol sequence. In one example, different Sync Word values can be used to identify different sections of the display packet in a C-PHY interface operated in accordance with a MIPI Alliance DSI protocol. In another example, different Sync Word values can be used to identify different sections of image data when a C-PHY interface is operated in accordance with a MIPI Alliance CSI protocol. The use of different Sync Word values can facilitate error recovery. For example, different Sync Word values enables a receiving device to recreate a packet in a reliable manner after some packet fields were not properly received. Conventional systems using a single type of Sync Word generally cannot reliably determine which sections are lost or corrupted, and packet reconstruction may be more difficult.

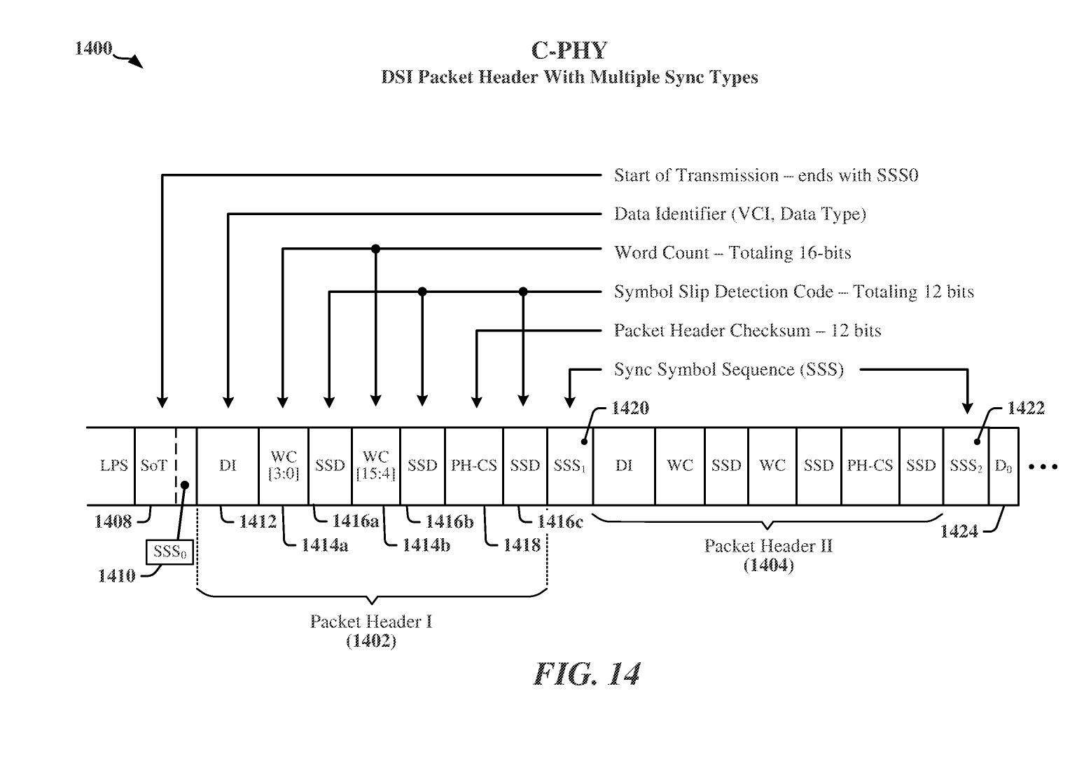

FIG. 14 illustrates the use of different Sync Word values in a C-PHY interface operated in accordance with the MIPI Alliance DSI-2 protocol. A partial DSI-2 Long Packet structure 1400 may be adapted according to certain aspects disclosed herein to include different Sync Word Types in the SSS₀ 1410, SSS₁ 1420 and SSS₂ 1422 sync symbol sequences that separate packet headers 1402, 1404 and/or the data payload (i.e. before first data 1424 transmitted in the payload. In the example, SSS₀ 1410 is provided in the start of transmission signaling (SoT 1408) that precedes the first copy of the packet header 1402, SSS₁ 1420 precedes the second copy of the packet header 1404, and SSS₂ 1422 precedes the Payload. A receiver may recognize the Sync Word Type used in a sync symbol sequence, and may determine the next type of information to be received from the Sync Word Type. The receiver may detect error conditions by identifying the Sync Word Type used in a sync symbol sequence. For example, a receiver may determine that a transmission error has occurred after receiving the first copy of the packet header 1402 preceded by the SSS₀ 1410 sync symbol sequence, if it next detects the SSS₂ 1422 sync symbol sequence. In this example, the receiver may determine that the second copy of the packet header 1404 has not been properly received.

Certain conventional C-PHY interfaces are configured to recognize a single sync symbol sequence. These C-PHY interfaces identify a 7-symbol Sync Word based on the first 6 symbols in the transmitted sync symbol sequence. The last symbol may be ignored. The 7-symbol sync symbol sequence has the value 344444x, where “x” represents a “don't care” symbol value. The purpose of recognizing only 6 of the 7 symbols is to provide error resilience in cases where there are symbol errors or where an error results in a duplicated wire-state which can cause a symbol clock-slip event.

In a C-PHY interface operated in accordance with certain aspects disclosed herein, all symbols in a 7-symbol sync symbol sequence can have significance. The last symbol value of the 7-symbol sync symbol sequence may serve as a Sync Word Type identifier. A receiver may detect the Sync Word based on the first 6 symbols in the sync symbol sequence, and may identify a Sync Type based on the value of the last symbol in the sync symbol sequence. Table 1 illustrates one allocation of Sync Word Types.

TABLE 1

| Sync Word Type | SSS Value |
|---|---|
| Type 0 (SSS₀) | 3444443 |
| Type 1 (SSS₁) | 3444441 |
| Type 2 (SSS₂) | 3444440 |
| Type 3 (SSS₃) | 3444442 |
| Type 4 (SSS₄) | 3444444 |

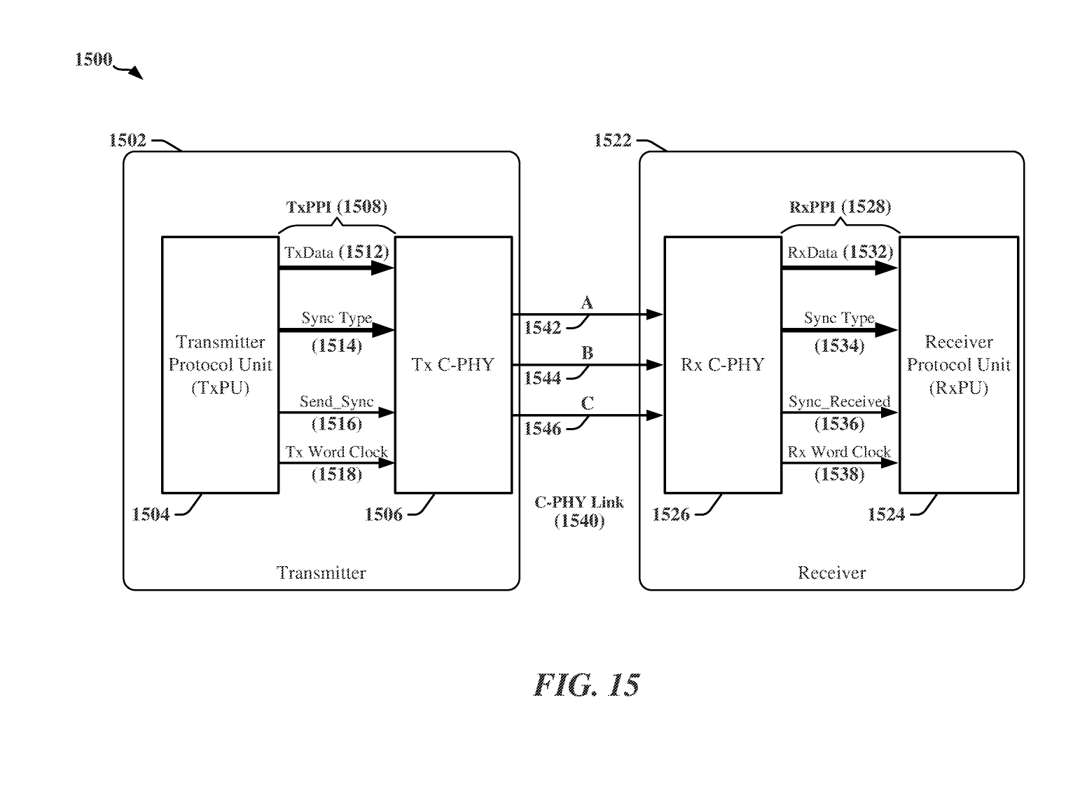

FIG. 15 illustrates an example of an apparatus 1500 adapted to support multiple Sync

Word Types. A transmitter 1502 includes a transmitter protocol unit (TxPU 1504) that communicates with the transmitter C-PHY interface 1506 through a transmitter PHY-Protocol Interface (TxPPI 1508). A receiver 1522 includes a receiver protocol unit (RxPU 1524) that communicates with the receiver C-PHY interface 1526 through a receiver PHY-Protocol Interface (RxPPI 1528). The transmitter 1502 and receiver 1522 are coupled to the three wires 1542, 1544, 1546 of the C-PHY link 1540.

In some implementations, the TxPU 1504 may send a Sync Word Type signal 1514 to be transmitted with transmit data (TxData 1512). The TxData 1512 may be a packet header, payload or some other unit of data. The transmitter C-PHY interface 1506 may use the Sync Word Type signal 1514 to select a corresponding SSS Value in a sync symbol sequence that precedes the TxData 1512 in transmission. The sync symbol sequence may be transmitted under control of the TxPU 1504 through a Send_Sync control signal 1516, for example. The TxPU 1504 may additionally select a Tx Word Clock 1518 to be used to clock transmissions on the C-PHY link 1540.

At the receiver 1522, a Sync Word Type may be determined from a received sync symbol sequence. The Sync Word Type may be reported in a signal 1534 through the RxPPI 1528 to the RxPU 1524. The RxPU can use this Sync Word Type to definitively identify different portions of a packet received as RxData 1532 through the RxPPI 1528. When an error event occurs that corrupts parts of a packet, the RxPPI 1528 may assemble other parts of the packet based on reported Sync Word Types.

Scrambling in CSI-2 C-PHY Interfaces

Progress in device technology has resulted in ever-increasing clock frequencies, and reduced feature sizes in IC devices. Increased frequency and decreased separation of signals can result in increased electromagnetic interference (EMI) that may affect the operation of a C-PHY Interface. Packet data scrambling using a pseudo-random binary sequence (PRBS) seed word may be implemented to combat and/or minimize EMI in some C-PHY and D-PHY Interfaces.

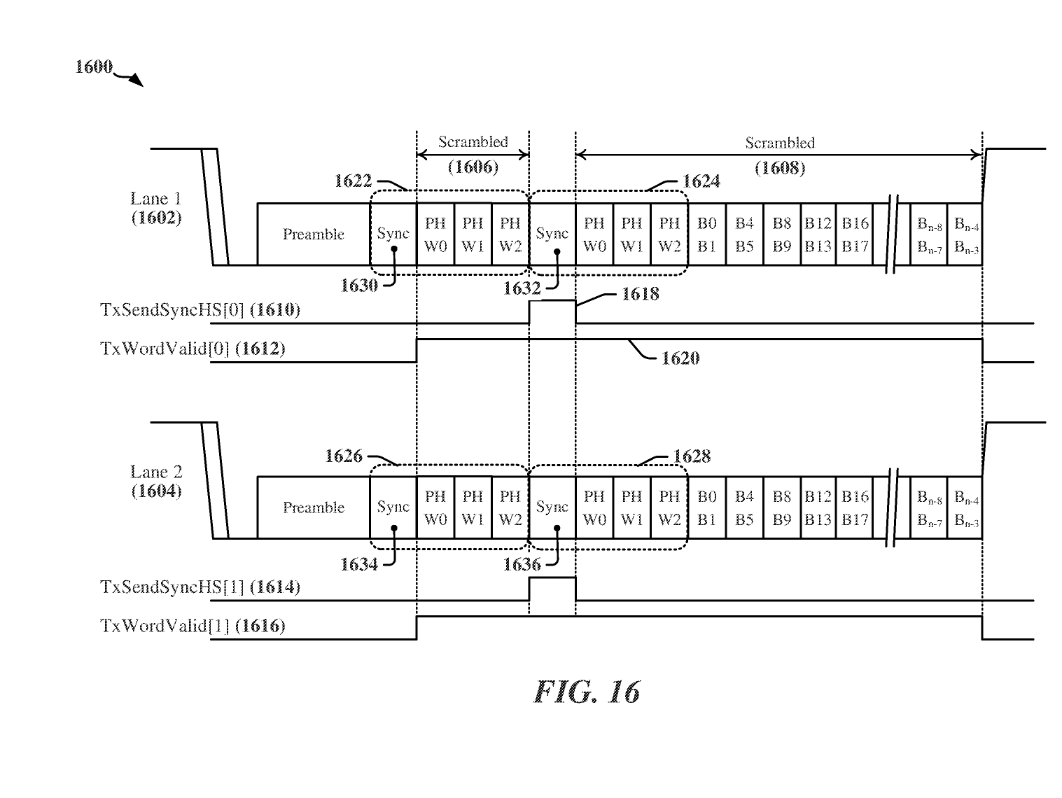

With reference to FIG. 16, scrambling may be used to avoid multiple identical symbol sequences occurring in a short period, which can result in increased EMI. In operation, the scrambler is initialized with the seed value during the transmission of a Sync Word 1630, 1632, 1634, 1636. Sync Words 1630, 1632, 1634, 1636 are not scrambled. Accordingly, in each scrambled transmission 1606, 1608, the scrambler may produce an identical transmission signal sequence corresponding to each copy of the packet header 1622, 1624 and 1626, 1628. The transmission of the identical transmission signals may result in increased EMI.

A Sync Word 1632, 1636 is transmitted before each packet header of the two duplicated packet headers in order to prevent propagation of errors caused by loss of synchronization in the first packet header 1622 or 1626 of the two duplicated packet headers. Loss of synchronization may occur due to a symbol error with symbol slip (extra symbol or symbol miss). The insertion of the second Sync Word 1632, 1636 can prevent the error effect from propagating through the rest of the transmission, including through the second packet header 1624 or 1628. In a C-PHY Interface, the Sync Word 1632, 1636 enables re-synchronization of a receiver to a C-PHY word boundary after occurrence of a symbol slip.

PRBS scrambling applied to a CSI-2 C-PHY packet results in two identical scrambled symbol sequences (which is what PRBS scrambling is designed to avoid) that can result in in larger EMI, because the PRBS scrambler is reset at the beginning of each duplicated packet header 1622, 1624 and 1626, 1628. The PRBS scrambler is reset at the occurrence of a Sync Word 1630, 1632, 1634, 1636 as part of the synchronization process. The reset of the PRBS scrambler allows a descrambler of the receiver to be reset at the same time and provide synchronization between the scrambling and descrambling functions.

Avoiding Identical Scrambled Symbol Sequences in C-PHY Interfaces

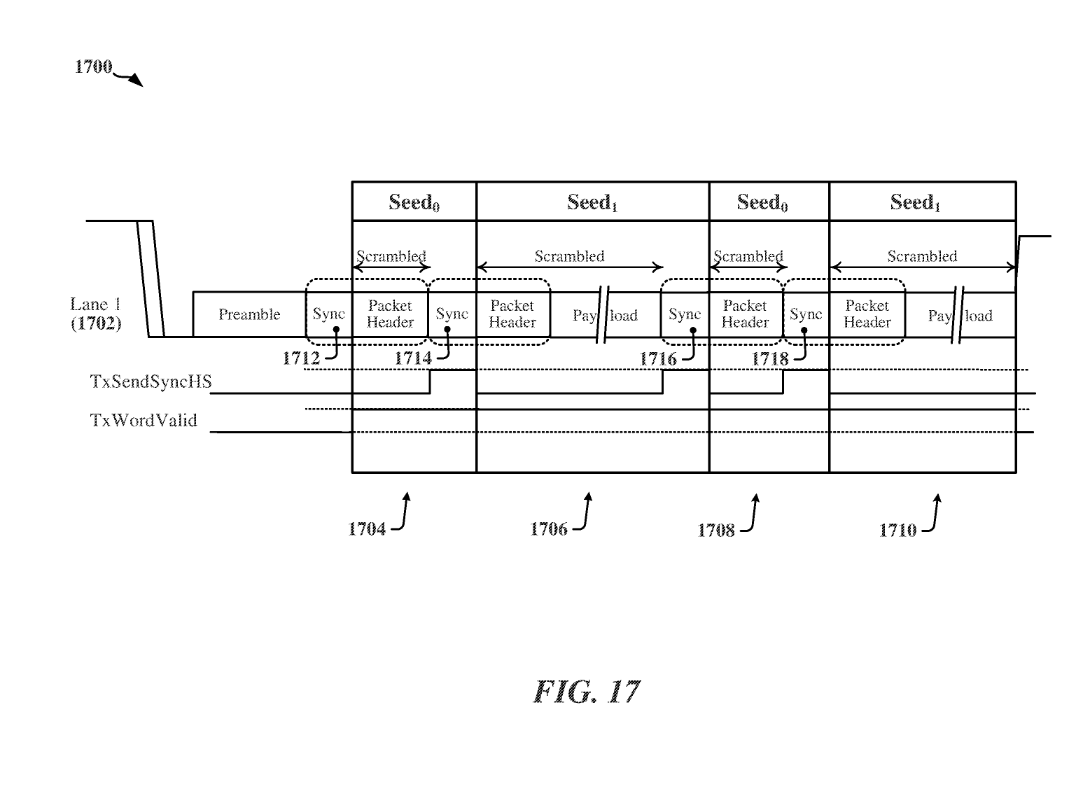

According to certain aspects disclosed herein, the occurrence of identical scrambled symbol sequences can be avoided in C-PHY interfaces through the use of multiple PRBS seed values, and/or by modifying the order or content of duplicated packet headers. FIG. 17 illustrates one example of scrambling in which the PRBS seed value is changed at every Sync Word 1712, 1714, 1716, 1718. In the example depicted, the seed word used to initialize the scrambler at each Sync Word 1712, 1714, 1716, 1718 toggles between two available seed words (Seed₀ and Seed₁). In the illustrated example, Seed₀ is used for scrambling during a first period 1704 that begins after the transmission of a first Sync Word 1712 and ends after transmission of a second Sync Word 1714. In this first period 1704, the first copy of the packet header in a first packet is scrambled. Seed₁ is used for scrambling during a second period 1706 that begins after the transmission of the second Sync Word 1714 and ends after transmission of a third Sync Word 1716. In this second period 1706, the second copy of the packet header in the first packet is scrambled. Seed₀ is used for scrambling during a third period 1708 that begins after the transmission of the third Sync Word 1716 and ends after transmission of a fourth Sync Word 1718. In this third period 1708, the first copy of the packet header in a second packet is scrambled. Seed₁ is used for scrambling during a fourth period 1710 that begins after the transmission of the fourth Sync Word 1718 and ends after transmission of another Sync Word or termination of the high-speed state. In this fourth period 1710 the second copy of the packet header in the second packet is scrambled.

In some examples, more than two seed values can be used as needed or desired. In some instances, different seed values may be used for different lanes. The scrambler may select seeds by alternating or toggling between two PRBS seeds as illustrated in FIG. 17 or cycling through a set of three or more seeds. In some instances, the order of selection of the seeds may be configurable.

In some instances, a Sync Word error may occur, and the error may result in the receiver and transmitter using different seed words for scrambling and descrambling, respectively. For example, a Sync Word error may cause the receiver to fail to synchronize to the first packet header, and the receiver may then view the second packet header which is scrambled using Seed₁ as the first packet header scrambled with Seed₀. The use of an incorrect seed word may be averted by using two different 7-symbol sequences to provide two Sync Word versions. When Sync Word versions are available, the transmitter may send one Sync Word in advance of the first packet header and a different Sync Word ahead of the second packet header. The receiver can then determine which packet header is being received by identifying the Sync Word proceeding the packet header. In some embodiments, two or more versions of the Sync Word may be defined, and each version may be associated with a different seed value. In these embodiments, the receiver may initialize the descrambler using the seed word assigned to the received preceding Sync Word.

In some examples, the effect of a Sync Word error may be limited by providing a receiver with two or more PRBS descramblers. Each PRBS descrambler may be configured with a different seed word and may decode the same packet header in parallel to one another. For example, a first descrambler may be configured to use Seed₀, while a second descrambler may be configured to use Seed₁ such that one of the descramblers produces a correctly descrambled second packet header regardless of any Sync Word error that may affect the first-transmitted packet header. The correctly descrambled packet header yields a correct CRC. If neither descrambled packet header produces a correct CRC, then there is a packet header error present in the received transmission.

In some examples, one of the duplicate packet headers may be altered in a predefined manner prior to scrambling in order to produce a different result when the same seed is used for scrambling both versions of the packet header. In one example, the order of fields in a duplicate packet header may be reversed. In another example, the endianess of one or more bytes may be changed in a duplicate packet header where endianess may refer to the order of bits in a byte or word. In another example, a counter value or other enumeration may be expressed differently in duplicate packets. In another example, one or more bytes may be subjected to binary inversion.

Scrambling Code Diversity and Identifying Scrambling Codes

According to certain aspects, more than two seed values may be defined for scrambling packet headers in a C-PHY interface. In some aspects, two or more types of Sync Word may be transmitted. Various combinations of seed values and Sync Word types may be used. For example, multiple seed values may be used with a single type of Sync Word, multiple seed values may be used with a multiple types of Sync Word, or a single seed value may be used with multiple types of Sync Word.

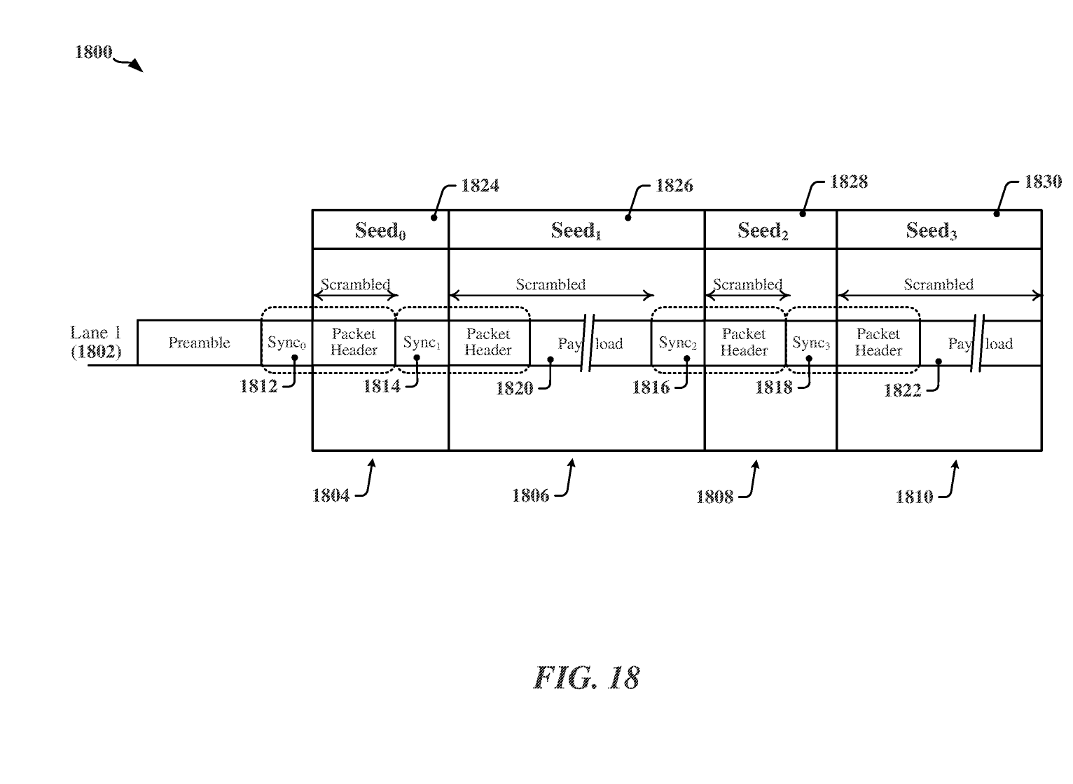

FIG. 18 illustrates an example 1800 in which packet headers may be scrambled using one or more PRBS seed values, and/or one or more types of Sync Word. In one example, the PRBS seed values 1824, 1826, 1828, 1830 may be changed at each Sync Word 1812, 1814, 1816, 1818 transmitted on the C-PHY interface. Any number of PRBS seed values 1824, 1826, 1828, 1830 may be available or used, and a device may be configurable to use different numbers of PRBS seed values 1824, 1826, 1828, 1830 in different circumstances. In another example, a device may be configured to use a single PRBS seed value 1824, 1826, 1828 or 1830 when link reliability is high or when another device coupled to the C-PHY interface has limited capabilities. In another example, a device may be configured to use two PRBS seed values 1824, 1826, 1828 and/or 1830 per the example illustrated in FIG. 17.

In some examples, multiple seed values may be used with multiple types of Sync Word. In one example, a device may be configured to use at least 4 PRBS seed values 1824, 1826, 1828, 1830, such that different PRBS seed values 1824, 1828 are used for payloads 1820, 1822 transmitted after a first Sync 1812, 1816 and for the payloads 1820, 1822 transmitted after the second Sync 1814, 1818. The PRBS seed values 1824, 1826, 1828, 1830 may be selected according to protocol and/or sequentially from a list of values provided to a transmitter and a receiver coupled to the C-PHY interface. The transmitter and receiver may employ state information associated with a state machine or other controller to select a seed value based on current state of transmission. State information may indicate the next expected transmission (next first header, second header, payload, etc.), state of the interface (synchronized, error, reset, etc.), for example.

When multiple seed values are used with multiple types of Sync Word, a transmitting device coupled to a receiving device through a C-PHY interface may indicate which PRBS seed value 1824, 1826, 1828, 1830 is being used to scramble a packet header. In some instances, the transmitting device may indicate a group (e.g. a pair) from which the PRBS seed values 1824, 1826, 1828, 1830 are selected to be used for scrambling packet headers for a current payload 1820, 1822. In some instances, the transmitting device may indicate an initial PRBS seed value 1824, 1826, 1828 or 1830 used for scrambling packet headers for a current payload 1820, 1822. In some implementations, the transmitting device may provide information related to usage of PRBS seed values 1824, 1826, 1828, 1830 in a transmission of configuration information. In some implementations, the transmitting device may provide information related to usage of PRBS seed values 1824, 1826, 1828, 1830 in “out-of-band” signaling.

In one example, out-of-band signaling may be implemented by providing multiple types of Sync Word 1812, 1814, 1816, 1818 that the transmitting device may use to identify PRBS seed values 1824, 1826, 1828, 1830. In this example, the transmitting device may transmit Sync Words 1812, 1814, 1816, 1818 that have a direct association with PRBS seed values 1824, 1826, 1828, 1830, or to groups of PRBS seed values 1824, 1826, 1828, 1830. In one example, a Sync Word 1812, 1814, 1816, 1818 may be defined for each available PRBS seed value 1824, 1826, 1828, 1830, and the transmitting device may select a PRBS seed value 1824, 1826, 1828, 1830 and its corresponding Sync Word 1812, 1814, 1816, 1818 using pseudo-random sequencing or any other algorithm or selection process. In another example, a Sync Word 1812, 1814, 1816, 1818 may be defined for a pair of the PRBS seed values 1824, 1826, 1828, 1830, and the transmitting device may select a pair of the PRBS seed values 1824, 1826, 1828, 1830 and a corresponding Sync Word 1812, 1814, 1816, 1818 for transmitting in advance of a payload 1820, 1822. In another example, a pseudo-random sequence used to select from the available PRBS seed values 1824, 1826, 1828, 1830 may itself be seeded based on the Sync Word 1812, 1814, 1816, 1818 used by the transmitter to initiate transmission of a payload 1820, 1822 or a transaction involving multiple payloads 1820, 1822.

In another example, a single seed value may be used with multiple types of Sync Word. Here, each copy of the packet header is scrambled using a common PRBS seed value (e.g., Seed₀=Seed₁=Seed₂=Seed₃) and the signaling state of the C-PHY interface may be manipulated by transmitting different types of Sync Word 1812, 1814, 1816, 1818. For example, the different types of Sync Word 1812, 1814, 1816, 1818 may be configured to leave the C-PHY interface in different signaling states after transmission of the Sync Word 1812, 1814, 1816, 1818 such that identical scrambled packet headers produce a different signaling pattern. In a C-PHY interface, a next-transmitted symbol is selected based on the preceding symbol. Accordingly, the first signaling state of the C-PHY interface attributable to the scrambled packet header is based in part on the signaling state of the C-PHY interface after a Sync Word 1812, 1814, 1816, 1818 has been transmitted. The same scrambled packet header produces a different sequence of signaling states for different starting signaling states of the C-PHY interface.

Different 7-symbol sequences may be provided for use as Sync Words 1812, 1814, 1816, 1818. When multiple Sync Word types are available, a transmitter may use one or more Sync Words 1812, 1814, 1816, 1818 to signal a receiver. For example, the transmitter may select different Sync Words 1812, 1814, 1816 or 1818 to precede different copies of the packet header. The Sync Word type may indicate that the first copy of the packet header is to follow, the second copy of the packet header is to follow, or the payload is to follow. In another example, the transmitter may use one or more Sync Words 1812, 1814, 1816, 1818 to indicate to a receiver which PRBS seed value 1824, 1826, 1828, 1830 was used to scramble the following packet header or payload.

Different Sync Word types may be implemented by modifying one or more symbols in a 7-symbol sequence. Referring also to FIG. 3, in the C-PHY interface, 16-bit words are converted to a 7-symbol sequence, where the sequence of symbols carries 2.32 bits per symbol. Each symbol encodes five states, and 78,125 permutations of 7-symbols are available for encoding 65,536 permutations of 16 bits in a data word. Accordingly, 12,589 7-bit sequences are available for use as control, symbol substitution when run-length limits are exceeded, or for defining the Sync Words 1812, 1814, 1816 or 1818. At least some of the 12,589 7-bit sequences produce a signaling pattern on the 3-wire C-PHY interface that permits a transmitter and receiver to initiate and synchronize clock generation logic. In some implementations, different Sync Word types may be obtained by configuring one or more symbols in the 7-symbol sequence. In one example, the last symbol in the 7-symbol sequence may be selected to indicate what type of transmission follows, and/or a PRBS seed value 1824, 1826, 1828, 1830 used to scramble following transmission.

When different Sync Words 1812, 1814, 1816 or 1818 are used to indicate seed-related information for a payload 1820, 1822, a receiver can select the appropriate PRBS seed values 1824, 1826, 1828, 1830 to configure its descrambler based on the received Sync Word 1812, 1814, 1816 or 1818. In some instances, a transmitter may employ an algorithm to select a PRBS seed value 1824, 1826, 1828, 1830 for scrambling the next packet header, and the transmitter may then select a corresponding Sync Word 1812, 1814, 1816 or 1818 to precede the scrambled packet header. The transmitter may select the seed value 1824, 1826, 1828, 1830 using an algorithm, pattern, a pseudo-random sequence, or other ordering or selection process.

In some implementations, different Sync Words 1812, 1814, 1816, 1818 may be associated with corresponding seed values by protocol. As illustrated in FIG. 15, a TxPU 1504 in a transmitter 1502 may provide a Sync Word Type signal 1514 that indicates a Sync Word 1812, 1814, 1816 or 1818 to be used by the Tx C-PHY interface 1506 for transmitting a portion of a packet or transaction. The Tx C-PHY interface 1506 may automatically select a seed value based on the Sync Word 1812, 1814, 1816, 1818 indicated by the TxPU 1504. The Rx C-PHY interface 1526 in the receiver 1522 automatically knows which Seed value to use when it identifies the Sync Word Type in the sync symbol sequence. The receiver need not know the expected order of transmission of seed values 1824, 1826, 1828, 1830 when multiple seed values 1824, 1826, 1828, 1830 are used.

Examples of Processing Circuits and Methods

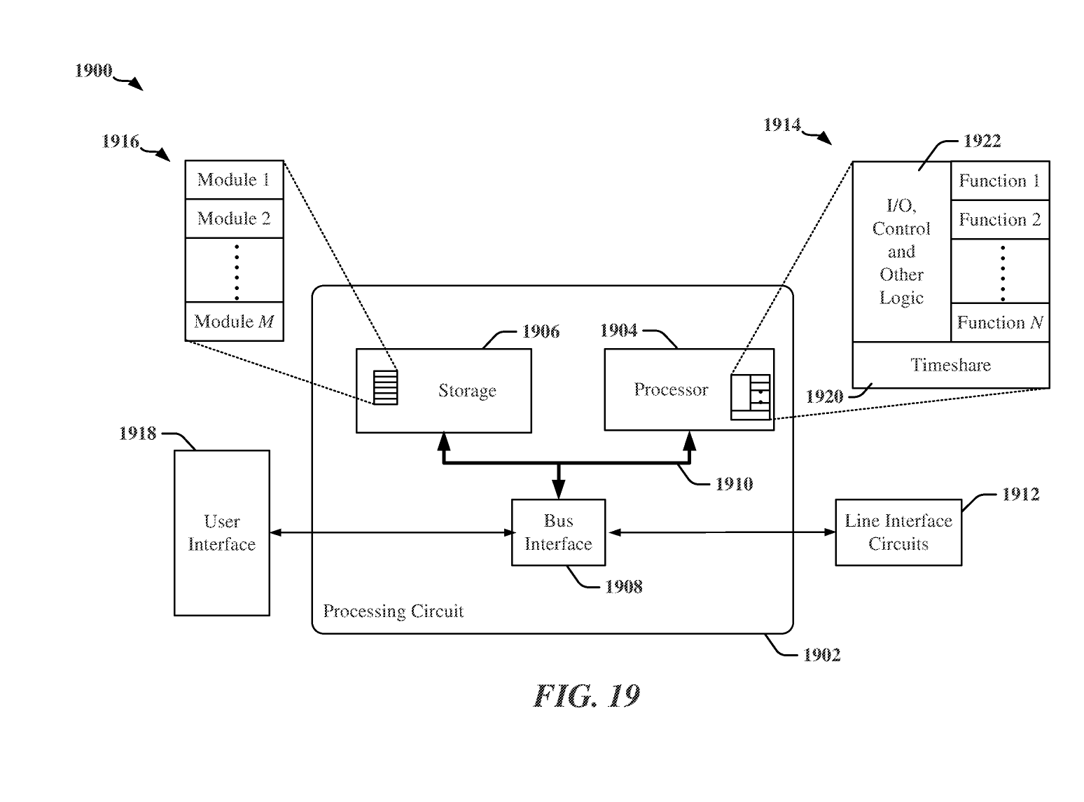

FIG. 19 is a conceptual diagram 1900 illustrating a simplified example of a hardware implementation for an apparatus employing a processing circuit 1902 that may be configured to perform one or more functions disclosed herein. In accordance with various aspects of the disclosure, an element, or any portion of an element, or any combination of elements as disclosed herein may be implemented using the processing circuit 1902. The processing circuit 1902 may include one or more processors 1904 that are controlled by some combination of hardware and software modules. Examples of processors 1904 include microprocessors, microcontrollers, digital signal processors (DSPs), ASICs field programmable gate arrays (FPGAs), programmable logic devices (PLDs), state machines, sequencers, gated logic, discrete hardware circuits, and other suitable hardware configured to perform the various functionality described throughout this disclosure. The one or more processors 1904 may include specialized processors that perform specific functions, and that may be configured, augmented or controlled by one of the software modules 1916. The one or more processors 1904 may be configured through a combination of software modules 1916 loaded during initialization, and further configured by loading or unloading one or more software modules 1916 during operation.

In the illustrated example, the processing circuit 1902 may be implemented with a bus architecture, represented generally by the bus 1910. The bus 1910 may include any number of interconnecting buses and bridges depending on the specific application of the processing circuit 1902 and the overall design constraints. The bus 1910 links together various circuits including the one or more processors 1904, and storage 1906. Storage 1906 may include memory devices and mass storage devices, and may be referred to herein as computer-readable media and/or processor-readable media. The bus 1910 may also link various other circuits such as timing sources, timers, peripherals, voltage regulators, and power management circuits. A bus interface 1908 may provide an interface between the bus 1910 and one or more line interface circuits 1912. A line interface circuit 1912 may be provided for each networking technology supported by the processing circuit. In some instances, multiple networking technologies may share some or all of the circuitry or processing modules found in a line interface circuit 1912. Each line interface circuit 1912 provides a means for communicating with various other apparatus over a transmission medium. Depending upon the nature of the apparatus, a user interface 1918 (e.g., keypad, display, speaker, microphone, joystick) may also be provided, and may be communicatively coupled to the bus 1910 directly or through the bus interface 1908.

A processor 1904 may be responsible for managing the bus 1910 and for general processing that may include the execution of software stored in a computer-readable medium that may include the storage 1906. In this respect, the processing circuit 1902, including the processor 1904, may be used to implement any of the methods, functions and techniques disclosed herein. The storage 1906 may be used for storing data that is manipulated by the processor 1904 when executing software, and the software may be configured to implement any one of the methods disclosed herein.

One or more processors 1904 in the processing circuit 1902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1906 or in an external computer readable medium. The external computer-readable medium and/or storage 1906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1906 may also include, by way of example, a carrier wave, a transmission line, and any other suitable medium for transmitting software and/or instructions that may be accessed and read by a computer. Computer-readable medium and/or the storage 1906 may reside in the processing circuit 1902, in the processor 1904, external to the processing circuit 1902, or be distributed across multiple entities including the processing circuit 1902. The computer-readable medium and/or storage 1906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1906 may maintain software maintained and/or organized in loadable code segments, modules, applications, programs, etc., which may be referred to herein as software modules 1916. Each of the software modules 1916 may include instructions and data that, when installed or loaded on the processing circuit 1902 and executed by the one or more processors 1904, contribute to a run-time image 1914 that controls the operation of the one or more processors 1904. When executed, certain instructions may cause the processing circuit 1902 to perform functions in accordance with certain methods, algorithms and processes described herein.

Some of the software modules 1916 may be loaded during initialization of the processing circuit 1902, and these software modules 1916 may configure the processing circuit 1902 to enable performance of the various functions disclosed herein. For example, some software modules 1916 may configure internal devices and/or logic circuits 1922 of the processor 1904, and may manage access to external devices such as the line interface circuit 1912, the bus interface 1908, the user interface 1918, timers, mathematical coprocessors, and so on. The software modules 1916 may include a control program and/or an operating system that interacts with interrupt handlers and device drivers, and that controls access to various resources provided by the processing circuit 1902. The resources may include memory, processing time, access to the line interface circuit 1912, the user interface 1918, and so on.

One or more processors 1904 of the processing circuit 1902 may be multifunctional, whereby some of the software modules 1916 are loaded and configured to perform different functions or different instances of the same function. The one or more processors 1904 may additionally be adapted to manage background tasks initiated in response to inputs from the user interface 1918, the line interface circuit 1912, and device drivers, for example. To support the performance of multiple functions, the one or more processors 1904 may be configured to provide a multitasking environment, whereby each of a plurality of functions is implemented as a set of tasks serviced by the one or more processors 1904 as needed or desired. In one example, the multitasking environment may be implemented using a timesharing program 1920 that passes control of a processor 1904 between different tasks, whereby each task returns control of the one or more processors 1904 to the timesharing program 1920 upon completion of any outstanding operations and/or in response to an input such as an interrupt. When a task has control of the one or more processors 1904, the processing circuit is effectively specialized for the purposes addressed by the function associated with the controlling task. The timesharing program 1920 may include an operating system, a main loop that transfers control on a round-robin basis, a function that allocates control of the one or more processors 1904 in accordance with a prioritization of the functions, and/or an interrupt driven main loop that responds to external events by providing control of the one or more processors 1904 to a handling function.

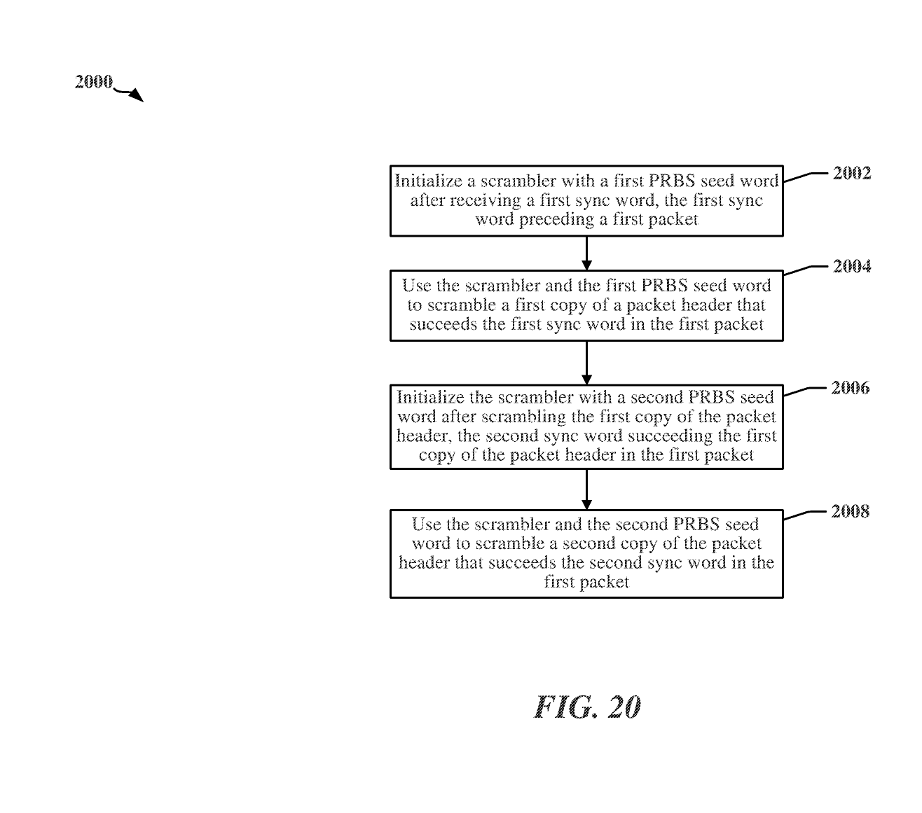

FIG. 20 is a flow chart 2000 of a method operational on a device configured for coupling to a multi-wire transition-encoded interface. In some examples, the multi-wire transition-encoded interface is a C-PHY interface defined by MIPI Alliance specifications.

At block 2002, the device may initialize a scrambler with a first PRBS seed word after receiving a first Sync Word. The first Sync Word may precede a first packet.

At block 2004, the device may use the scrambler and the first PRBS seed word to scramble a first copy of a packet header that succeeds the first Sync Word in the first packet.

At block 2006, the device may initialize the scrambler with a second PRBS seed word after scrambling the first copy of the packet header. The second Sync Word may succeed the first copy of the packet header in the first packet.

At block 2008, the device may use the scrambler and the second PRBS seed word to scramble a second copy of the packet header that succeeds the second Sync Word in the first packet.

In one example, the device may initialize the scrambler with the first PRBS seed word after receiving a third Sync Word. The third Sync Word may precede a second packet.

In another example, the device may initialize the scrambler with a third PRBS seed word after receiving a third Sync Word. The third Sync Word may precede a second packet.

In some instances, the device may scramble a payload of the first packet using the second PRBS seed word. The device may encode the first packet in sequences of symbols after scrambling the first copy of the packet header, the second copy of the packet header and the payload of the first packet.

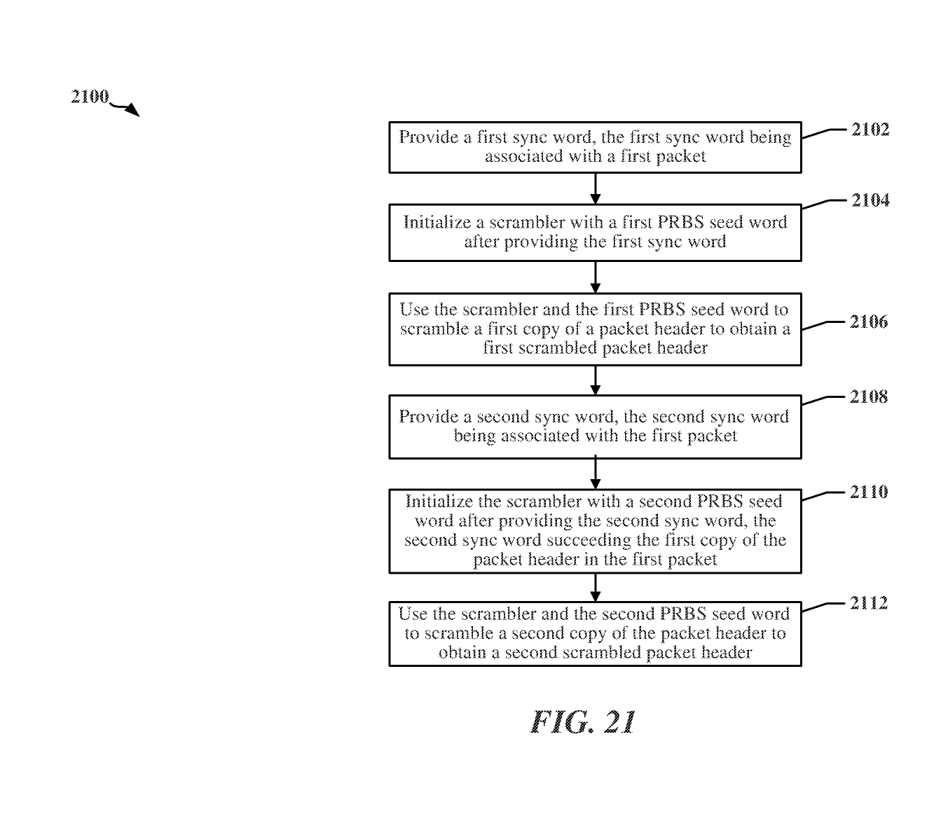

FIG. 21 is a flow chart 2100 of a method operational on a device configured for coupling to a multi-wire transition-encoded interface. In some examples, the multi-wire transition-encoded interface is a C-PHY interface defined by MIPI Alliance specifications.

At block 2102, the device may provide a first Sync Word. The first Sync Word may be associated with a first packet. For example, the first Sync Word may precede the first packet in transmission.

At block 2104, the device may initialize a scrambler with a first PRBS seed word after providing the first Sync Word.

At block 2106, the device may use the scrambler and the first PRBS seed word to scramble a first copy of a packet header to obtain a first scrambled packet header.

At block 2108, the device may provide a second Sync Word. The second Sync Word may be associated with the first packet. For example, the second Sync Word may precede the first packet in transmission and be transmitted after the first Sync Word.

At block 2110, the device may initialize the scrambler with a second PRBS seed word after providing the second Sync Word.

At block 2112, the device may use the scrambler and the second PRBS seed word to scramble a second copy of the packet header to obtain a second scrambled packet header.

In some examples, the device may transmit the first Sync Word followed by the first scrambled packet header on the multi-wire transition-encoded interface. After transmitting the first scrambled packet header, the device may transmit the second Sync Word followed by the second scrambled packet header on the multi-wire transition-encoded interface. After transmitting the second scrambled packet header, the device may transmit the packet on the multi-wire transition-encoded interface.

In some instances, the device may provide a third Sync Word. The third Sync Word may be associated with a second packet. For example, the third Sync Word may precede the second packet in transmission. The device may initialize the scrambler with a third PRBS seed word after providing the third Sync Word. In one example, the first Sync Word and the third Sync Word have a same value.

In another example, the first Sync Word, the second Sync Word, and the third Sync Word have different values. The first Sync Word may be transmitted on the multi-wire transition-encoded interface only when the scrambler is initiated with the first PRBS seed word. The second Sync Word may be transmitted on the multi-wire transition-encoded interface only when the scrambler is initiated with the second PRBS seed word. The third Sync Word may be transmitted on the multi-wire transition-encoded interface only when the scrambler is initiated with the third PRBS seed word.

In another example, the first Sync Word, the second Sync Word, and the third Sync Word are selected according to a pseudorandom sequence.

In some instances, the device may scramble a payload of the first packet using the second PRBS seed word. The device may encode the first packet in sequences of symbols after scrambling the first copy of the packet header, the second copy of the packet header and the payload of the first packet. The device may transmit the first packet over the multi-wire transition-encoded interface in sequences of symbols after scrambling the first copy of the packet header, the second copy of the packet header and the payload of the first packet.

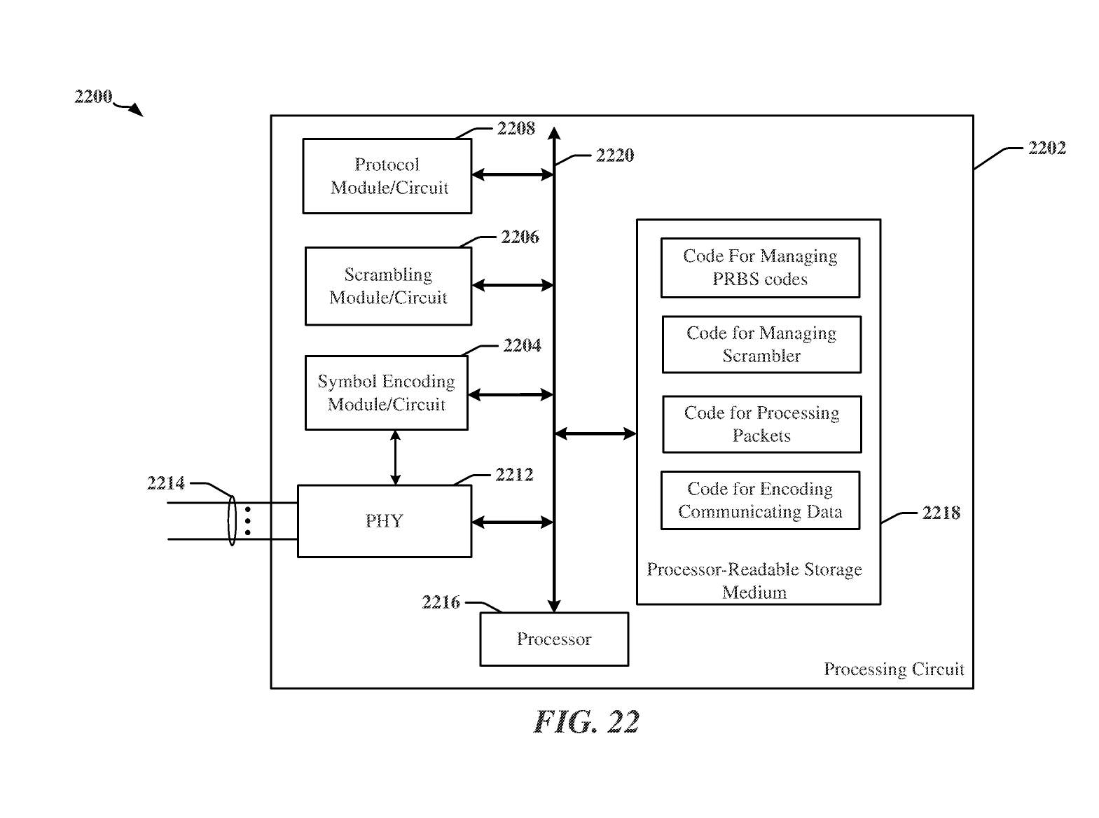

FIG. 22 is a diagram illustrating a simplified example of a hardware implementation for an apparatus 2200 employing a processing circuit 2202. The processing circuit typically has a processor 2216 that may include one or more of a microprocessor, microcontroller, digital signal processor, a sequencer and a state machine. The processing circuit 2202 may be implemented with a bus architecture, represented generally by the bus 2220. The bus 2220 may include any number of interconnecting buses and bridges depending on the specific application of the processing circuit 2202 and the overall design constraints. The bus 2220 links together various circuits including one or more processors and/or hardware modules, represented by the processor 2216, the modules or circuits 2204, 2206, and 2208, a PHY 2212 configurable to communicate over connectors or wires of a multi-wire communication link 2214 and the computer-readable storage medium 2218. The bus 2220 may also link various other circuits such as timing sources, peripherals, voltage regulators, and power management circuits.

The processor 2216 is responsible for general processing, including the execution of software stored on the computer-readable storage medium 2218. The software, when executed by the processor 2216, causes the processing circuit 2202 to perform the various functions described supra for any particular apparatus. The computer-readable storage medium 2218 may also be used for storing data that is manipulated by the processor 2216 when executing software, including data decoded from symbols transmitted over the communication link 2214, which may be configured as data lanes and clock lanes. The processing circuit 2202 further includes at least one of the modules 2204, 2206, and 2208. The modules 2204, 2206, and 2208 may be software modules running in the processor 2216, resident/stored in the computer-readable storage medium 2218, one or more hardware modules coupled to the processor 2216, or some combination thereof. The 2204, 2206, and/or 2208 may include microcontroller instructions, state machine configuration parameters, or some combination thereof.

In one configuration, the apparatus 2200 for data communication includes modules and/or circuits 2208 configured to receive and process packets for transmission over the communication link 2214, modules and/or circuits 2206 configured to scramble each packet using a plurality of seeds, and modules and/or circuits 2204, 2212 configured to encode scrambled data in sequences of symbols to be transmitted over the communication link 2214.

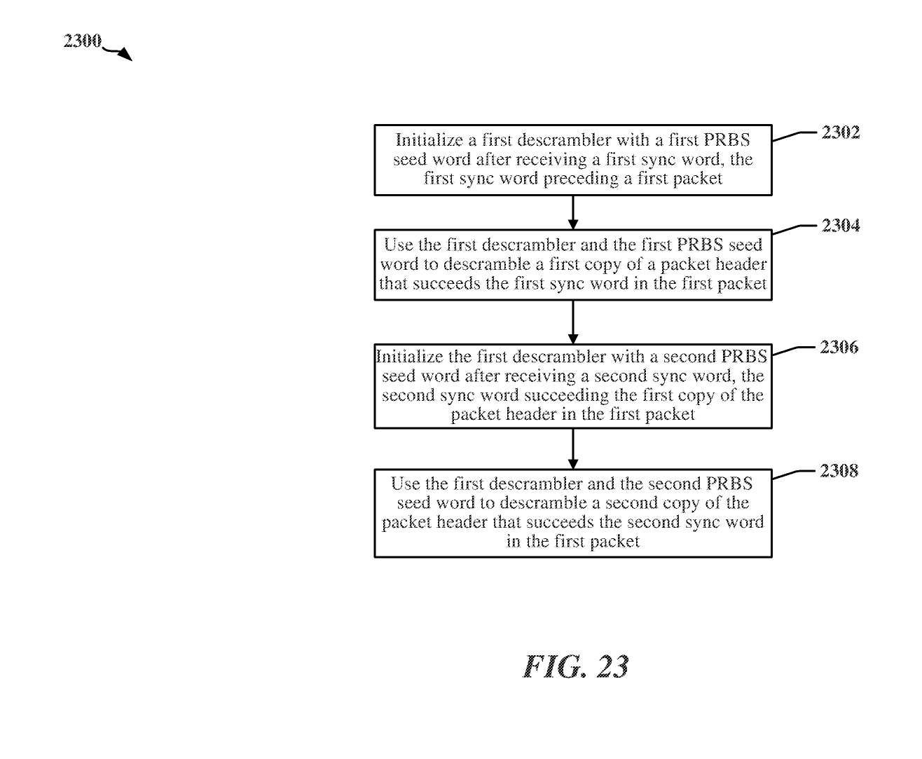

FIG. 23 is a flow chart 2300 of a method operational a device configured for coupling to a multi-wire transition-encoded interface. In some examples, the multi-wire transition-encoded interface is a C-PHY interface defined by MIPI Alliance specifications.

At block 2302, the device may initialize a first descrambler with a first PRBS seed word after receiving a first Sync Word, the first Sync Word preceding a first packet.

At block 2304, the device may use the first descrambler and the first PRBS seed word to descramble a first copy of a packet header that succeeds the first Sync Word in the first packet.

At block 2306, the device may initialize the first descrambler with a second PRBS seed word after receiving a second Sync Word, the second Sync Word succeeding the first copy of the packet header in the first packet.

At block 2308, the device may use the first descrambler and the second PRBS seed word to descramble a second copy of the packet header that succeeds the second Sync Word in the first packet.

In one example, the multi-wire transition-encoded interface is a C-PHY interface defined by Mobile Industry Processor Interface (MIPI) Alliance specifications.

In some instances, the device may initialize the first descrambler with the first PRBS seed word after receiving a third Sync Word, where the third Sync Word precedes a second packet.

In some instances, the device may initialize the first descrambler with a third PRBS seed word after receiving a third Sync Word, where the third Sync Word precedes a second packet. The device may descramble a payload of the first packet using the second PRBS seed word.

In some instances, the device may initialize the first descrambler with the first PRBS seed word after receiving a third Sync Word, the third Sync Word preceding a second packet, initialize a second descrambler with the second PRBS seed word after receiving the third Sync Word, use the first descrambler and the first PRBS seed word to descramble a header in the second packet, use the second descrambler and the second PRBS seed word to descramble the header in the second packet, and determine which of the first PRBS seed word and the second PRBS seed word was used to scramble the header based on CRC information in outputs of the first descrambler and the second descrambler. The CRC information may also identify when a packet header has been affected by transmission errors.

In one example, the first sync word, the second sync word, and the third sync word may be selected according to a pseudorandom sequence. In another example, the type or value of the sync word to be transmitted may be used to determine which seed word is provided for initializing the scrambler. In another example, the first PRBS seed word is used for scrambling after the first sync word is transmitted, the second PRBS seed word is used for scrambling after the second sync word is transmitted, and the third PRBS seed word is used for scrambling after the third sync word is transmitted.

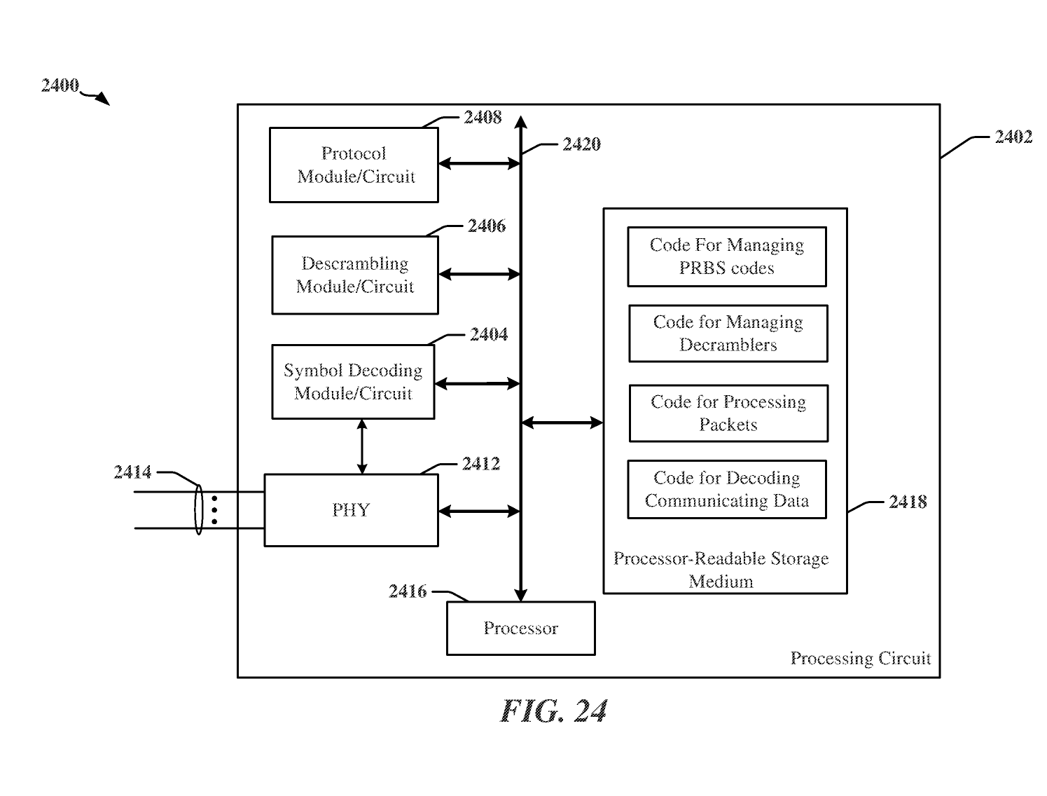

FIG. 24 is a diagram illustrating a simplified example of a hardware implementation for an apparatus 2400 employing a processing circuit 2402. The processing circuit typically has a processor 2416 that may include one or more of a microprocessor, microcontroller, digital signal processor, a sequencer and a state machine. The processing circuit 2402 may be implemented with a bus architecture, represented generally by the bus 2420. The bus 2420 may include any number of interconnecting buses and bridges depending on the specific application of the processing circuit 2402 and the overall design constraints. The bus 2420 links together various circuits including one or more processors and/or hardware modules, represented by the processor 2416, the modules or circuits 2404, 2406, and 2408, a PHY 2412 configurable to communicate over connectors or wires of a multi-wire communication link 2414 and the computer-readable storage medium 2418. The bus 2420 may also link various other circuits such as timing sources, peripherals, voltage regulators, and power management circuits.

The processor 2416 is responsible for general processing, including the execution of software stored on the computer-readable storage medium 2418. The software, when executed by the processor 2416, causes the processing circuit 2402 to perform the various functions described supra for any particular apparatus. The computer-readable storage medium 2418 may also be used for storing data that is manipulated by the processor 2416 when executing software, including data decoded from symbols transmitted over the communication link 2414, which may be configured as data lanes and clock lanes. The processing circuit 2402 further includes at least one of the modules 2404, 2406, and 2408. The modules 2404, 2406, and 2408 may be software modules running in the processor 2416, resident/stored in the computer-readable storage medium 2418, one or more hardware modules coupled to the processor 2416, or some combination thereof. The 2404, 2406, and/or 2408 may include microcontroller instructions, state machine configuration parameters, or some combination thereof.

In one configuration, the apparatus 2400 for data communication includes modules and/or circuits 2408 configured to receive and process packets from the communication link 2414, modules and/or circuits 2406 configured to descramble each packet using a plurality of seeds, and modules and/or circuits 2404, 2412 configured to decode scrambled data in sequences of symbols received from the communication link 2414.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for scrambling packets to be transmitted on a multi-wire transition-encoded interface, comprising:
providing a first sync word, the first sync word being associated with a first packet;
initializing a scrambler with a first pseudo-random binary sequence (PRBS) seed word after providing the first sync word;
using the scrambler and the first PRBS seed word to scramble a first copy of a packet header to obtain a first scrambled packet header;
providing a second sync word, the second sync word being associated with the first packet;
initializing the scrambler with a second PRBS seed word after providing the second sync word; and
using the scrambler and the second PRBS seed word to scramble a second copy of the packet header to obtain a second scrambled packet header.

2. The method of claim 1, wherein the multi-wire transition-encoded interface is a C-PHY interface defined by Mobile Industry Processor Interface (MIPI) Alliance specifications.

3. The method of claim 1, further comprising:
transmitting the first sync word followed by the first scrambled packet header on the multi-wire transition-encoded interface;
after transmitting the first scrambled packet header, transmitting the second sync word followed by the second scrambled packet header on the multi-wire transition-encoded interface; and
after transmitting the second scrambled packet header, transmitting the packet on the multi-wire transition-encoded interface.

4. The method of claim 1, further comprising:
providing a third sync word, the third sync word being associated with a second packet; and
initializing the scrambler with a third PRBS seed word after providing the third sync word.

5. The method of claim 4, wherein the first sync word and the third sync word have a same value.

6. The method of claim 4, wherein:
the first sync word, the second sync word, and the third sync word have different values;
the first sync word is transmitted on the multi-wire transition-encoded interface only when the scrambler is initiated with the first PRBS seed word;
the second sync word is transmitted on the multi-wire transition-encoded interface only when the scrambler is initiated with the second PRBS seed word; and
the third sync word is transmitted on the multi-wire transition-encoded interface only when the scrambler is initiated with the third PRBS seed word.

7. The method of claim 4, wherein the first sync word, the second sync word, and the third sync word are selected according to a pseudorandom sequence.

8. The method of claim 4, wherein the first PRBS seed word is used for scrambling after the first sync word is transmitted, the second PRBS seed word is used for scrambling after the second sync word is transmitted, and the third PRBS seed word is used for scrambling after the third sync word is transmitted.

9. The method of claim 1, further comprising:
scrambling a payload of the first packet using the second PRBS seed word; and
encoding the first packet in sequences of symbols after scrambling the first copy of the packet header, the second copy of the packet header and the payload of the first packet.

10. The method of claim 9, further comprising:
transmitting the first packet over the multi-wire transition-encoded interface in sequences of symbols after scrambling the first copy of the packet header, the second copy of the packet header and the payload of the first packet.

11. An apparatus comprising:
a physical interface configured for communicating over a multi-wire transition-encoded interface;
a scrambler; and
a processor configured to:
provide a first sync word, the first sync word being associated with a first packet;
initialize a scrambler with a first pseudo-random binary sequence (PRBS) seed word after providing the first sync word;
cause the scrambler to scramble a first copy of a packet header using the first PRBS seed word to obtain a first scrambled packet header;
provide a second sync word, the second sync word being associated with the first packet;
initialize the scrambler with a second PRBS seed word after providing the second sync word; and
cause the scrambler to scramble a second copy of the packet header using the second PRBS seed word to obtain a second scrambled packet header.

12. The apparatus of claim 11, wherein the multi-wire transition-encoded interface is a C-PHY interface defined by Mobile Industry Processor Interface (MIPI) Alliance specifications.

13. The apparatus of claim 11, wherein the processor is configured to:
transmit the first sync word followed by the first scrambled packet header on the multi-wire transition-encoded interface;
after transmitting the first scrambled packet header, transmit the second sync word followed by the second scrambled packet header on the multi-wire transition-encoded interface; and
after transmitting the second scrambled packet header, transmit the packet on the multi-wire transition-encoded interface.

14. The apparatus of claim 11, wherein the processor is configured to:
provide a third sync word, the third sync word being associated with a second packet; and
initialize the scrambler with a third PRBS seed word after providing the third sync word.

15. The apparatus of claim 14, wherein the first sync word and the third sync word have a same value.

16. The apparatus of claim 14, wherein:
the first sync word, the second sync word, and the third sync word have different values;
the first sync word is transmitted on the multi-wire transition-encoded interface only when the scrambler is initiated with the first PRBS seed word;
the second sync word is transmitted on the multi-wire transition-encoded interface only when the scrambler is initiated with the second PRBS seed word; and
the third sync word is transmitted on the multi-wire transition-encoded interface only when the scrambler is initiated with the third PRBS seed word.

17. The apparatus of claim 14, wherein the first sync word, the second sync word, and the third sync word are selected according to a pseudorandom sequence.

18. The apparatus of claim 17, wherein the processor is configured to:
cause the scrambler to scramble a payload of the first packet using the second PRBS seed word; and
encode the first packet in sequences of symbols after the first copy of the packet header, the second copy of the packet header and the payload of the first packet have been scrambled, wherein clock information is embedded in transitions between each pair of consecutive symbols in the sequences of symbols.

19. A method for descrambling packets received a multi-wire transition-encoded interface, comprising:
initializing a first descrambler with a first pseudo-random binary sequence (PRBS) seed word after receiving a first sync word, the first sync word preceding a first packet;
using the first descrambler and the first PRBS seed word to descramble a first copy of a packet header that succeeds the first sync word in the first packet;
initializing the first descrambler with a second PRBS seed word after receiving a second sync word, the second sync word succeeding the first copy of the packet header in the first packet; and
using the first descrambler and the second PRBS seed word to descramble a second copy of the packet header that succeeds the second sync word in the first packet.

20. The method of claim 19, wherein the multi-wire transition-encoded interface is a C-PHY interface defined by Mobile Industry Processor Interface (MIPI) Alliance specifications.

21. The method of claim 19, further comprising:
initializing the first descrambler with the first PRBS seed word after receiving a third sync word, wherein the third sync word precedes a second packet.

22. The method of claim 19, further comprising:
initializing the first descrambler with a third PRBS seed word after receiving a third sync word, wherein the third sync word precedes a second packet.

23. The method of claim 19, further comprising:
descrambling a payload of the first packet using the second PRBS seed word.

24. The method of claim 19, further comprising:
initializing the first descrambler with the first PRBS seed word after receiving a third sync word, the third sync word preceding a second packet;
initializing a second descrambler with the second PRBS seed word after receiving the third sync word;
using the first descrambler and the first PRBS seed word to descramble a header in the second packet;
using the second descrambler and the second PRBS seed word to descramble the header in the second packet; and
determining which of the first PRBS seed word and the second PRBS seed word was used to scramble the header based on CRC information in outputs of the first descrambler and the second descrambler.

25. The method of claim 19, wherein the first sync word and the second sync word comprise different sequences of symbols.

26. An apparatus, comprising:
means for configuring one or more descramblers, and configured to:
initialize a first descrambler with a first pseudo-random binary sequence (PRBS) seed word after receiving a first sync word, the first sync word preceding a first packet; and
initializing the first descrambler with a second PRBS seed word after receiving a second sync word;
means for descrambling a first copy of a packet header that succeeds the first sync word in the first packet, using the first descrambler and the first PRBS seed word; and
means for descrambling a second copy of the packet header that succeeds the second sync word in the first packet, using the first descrambler and the first PRBS seed word, wherein the second sync word follows the first copy of the packet header in the first packet.

27. The apparatus of claim 26, wherein the means for configuring one or more descramblers is configured to:
initialize the first descrambler with the first PRBS seed word after receiving a third sync word, wherein the third sync word precedes a second packet.

28. The apparatus of claim 26, wherein:
the means for configuring one or more descramblers is configured to initialize the first descrambler with a third PRBS seed word after receiving a third sync word, wherein the third sync word precedes a second packet; and
the means for descrambling a second copy of the packet header is further configured to descramble a payload of the first packet using the second PRBS seed word.

29. The apparatus of claim 26, wherein:
the means for configuring one or more descramblers is configured to initialize the first descrambler with the first PRBS seed word after receiving a third sync word, the third sync word preceding a second packet;
the means for configuring one or more descramblers is configured to initialize a second descrambler with the second PRBS seed word after receiving the third sync word;
the means for descrambling the first copy of the packet header is configured to use the first descrambler and the first PRBS seed word to descramble a header in the second packet;
the means for descrambling the first copy of the packet header is configured to use the second descrambler and the second PRBS seed word to descramble the header in the second packet; and
CRC information in outputs of the first descrambler and the second descrambler are used to determine which of the first PRBS seed word and the second PRBS seed word was used to scramble the header.

30. The apparatus of claim 26, wherein the first sync word and the second sync word comprise different sequences of symbols.
